(19) United States
(12) Patent Application Publication
(10) Pub. No.: US 2014/0343737 A1
(43) Pub. Date: Nov. 20, 2014

(54) TECHNIQUES FOR CONTROLLING FLUID DISTRIBUTION

(71) Applicant: Dzuy H. Nguyen, Austin, TX (US)

(72) Inventor: Dzuy H. Nguyen, Austin, TX (US)

(21) Appl. No.: 14/277,402

(22) Filed: May 14, 2014

Related U.S. Application Data
(60) Provisional application No. 61/823,910, filed on May 15, 2013.

(51) Int. Cl. A01G 25/16; G05B 15/02

(52) U.S. Cl. CPC A01G 25/16; G05B 15/02
USPC 700/284

(57) ABSTRACT

A technique for operating an irrigation controller includes receiving, via a communication interface, a request from a computing device. First data is communicated, via the communication interface, to the computing device in response to the request. The first data includes a user interface that is displayable via a web browser of the computing device. User data input via the user interface of the computing device is received, via the communication interface. At least one electrically actuated fluid valve that is mechanically coupled to one or more in-ground sprinkler heads is controlled based on the received user data.

This application claims the benefit of the filing date of U.S. Provisional Patent Application Ser. No. 61/823,910, filed on May 15, 2013, and entitled “METHODS AND SYSTEMS OF CONTROLLING FLUID DISTRIBUTION.” The disclosure of U.S. Provisional Patent Application Ser. No. 61/823,910 is hereby incorporated herein by reference in its entirety for all purposes.

### BACKGROUND

This disclosure relates generally to the field of controlling fluid distribution and, more specifically, this disclosure pertains to the field of controlling fluid distribution that can be configured via a configuration graphical user interface.

Fluid distribution systems are typically difficult to configure. Typically, a fluid distribution system has one or more timers that have to be manually configured. Further, currently available irrigation and/or sprinkler system controllers offer limited configuration capabilities via poor and/or confusing user interfaces. For example, once a current irrigation and/or sprinkler system is configured, it waters at the same time everyday. This provides no configuration settings for seasonal weather changes, unless the system is reconfigured at a beginning of each season. For example, lawns and/or gardens may require less water during one or more cooler seasons.

### BRIEF SUMMARY

A technique for operating an irrigation controller includes receiving, via a communication interface, a request from a computing device. First data is communicated, via the communication interface, to the computing device in response to the request. The first data includes a user interface that is displayable via a web browser of the computing device. User data input via the user interface of the computing device is received, via the communication interface. At least one electrically actuated fluid valve that is mechanically coupled to one or more in-ground sprinkler heads is controlled based on the received user data.

### BRIEF DESCRIPTION OF THE DRAWINGS

The embodiments will become apparent upon reading the following detailed description and upon reference to the accompanying drawings in which:

FIG. 1 provides an exemplary block diagram of a fluid distribution system, according to one or more embodiments;

FIG. 2 provides another exemplary block diagram of a fluid distribution system, according to one or more embodiments;

FIG. 3 provides an exemplary block diagram of a control system of a fluid distribution system, according to one or more embodiments;

FIG. 4 provides another exemplary block diagram of a control system of a fluid distribution system, according to one or more embodiments;

FIG. 5 provides an exemplary block diagram of an exemplary device of a control system of a fluid distribution system, according to one or more embodiments;

FIG. 6 illustrates an exemplary user interface, according to one or more embodiments;

FIG. 7 provides an exemplary view of a data interface, according to one or more embodiments;

FIGS. 8 and 9 provide exemplary views of a data interface that displays one or more zone icons and/or graphics, according to one or more embodiments;

FIG. 10 illustrates an exemplary zone control menu, according to one or more embodiments;

FIG. 11 illustrates an exemplary program interface, according to one or more embodiments;

FIG. 12 illustrates an exemplary seasonal setting interface, according to one or more embodiments;

FIG. 13 illustrates an exemplary schedules interface, according to one or more embodiments;

FIG. 14 illustrates an exemplary sensor settings interface, according to one or more embodiments;

FIG. 15 illustrates an exemplary operational settings interface, according to one or more embodiments;

FIG. 16 illustrates an exemplary weather settings interface, according to one or more embodiments;

FIG. 17 illustrates an exemplary system settings interface, according to one or more embodiments;

FIG. 18 illustrates an exemplary wireless access point search menu, according to one or more embodiments;

FIG. 19 illustrates an exemplary administration interface, according to one or more embodiments;

FIGS. 20 and 21 provide exemplary database table schemas, according to one or more embodiments;

FIG. 22 provides an exemplary diagram of computing devices coupled to a control system, according to one or more embodiments;

FIG. 23 provides an exemplary diagram of computing devices coupled to a control system that is coupled to a network, according to one or more embodiments;

FIG. 24 provides an exemplary diagram of computing devices and a control system coupled to an access point that is coupled to a network, according to one or more embodiments;

FIGS. 25 and 26 illustrate a method of providing and operating an interface of a system, according to one or more embodiments;

FIG. 27 illustrates an exemplary method of placing and/or removing zones of a fluid distribution system, according to one or more embodiments;

FIG. 28 illustrates an exemplary method of operating a program interface of a fluid distribution system, according to one or more embodiments;

FIG. 29 illustrates an exemplary method of operating a seasonal setting interface of a fluid distribution system, according to one or more embodiments;

FIG. 30 illustrates an exemplary method of operating a schedules interface of a fluid distribution system, according to one or more embodiments;

FIG. 31 illustrates an exemplary method of operating a sensor settings interface, according to one or more embodiments;

FIG. 32 illustrates an exemplary method of operating an operational settings interface, according to one or more embodiments;

FIG. 33 illustrates an exemplary method of operating a weather settings interface, according to one or more embodiments;

FIG. 34 illustrates an exemplary method of operating a system settings interface, according to one or more embodiments;

FIG. 35 illustrates an exemplary method of operating an administration interface, according to one or more embodiments;

FIG. 36 illustrates exemplary graphics of a watering system, according to one or more embodiments;

FIG. 37 illustrates an exemplary method of operating a fluid distribution controller, according to one or more embodiments; and

FIG. 38 illustrates an exemplary method of running a program corresponding to a schedule, according to one or more embodiments.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of this disclosure.

### DETAILED DESCRIPTION

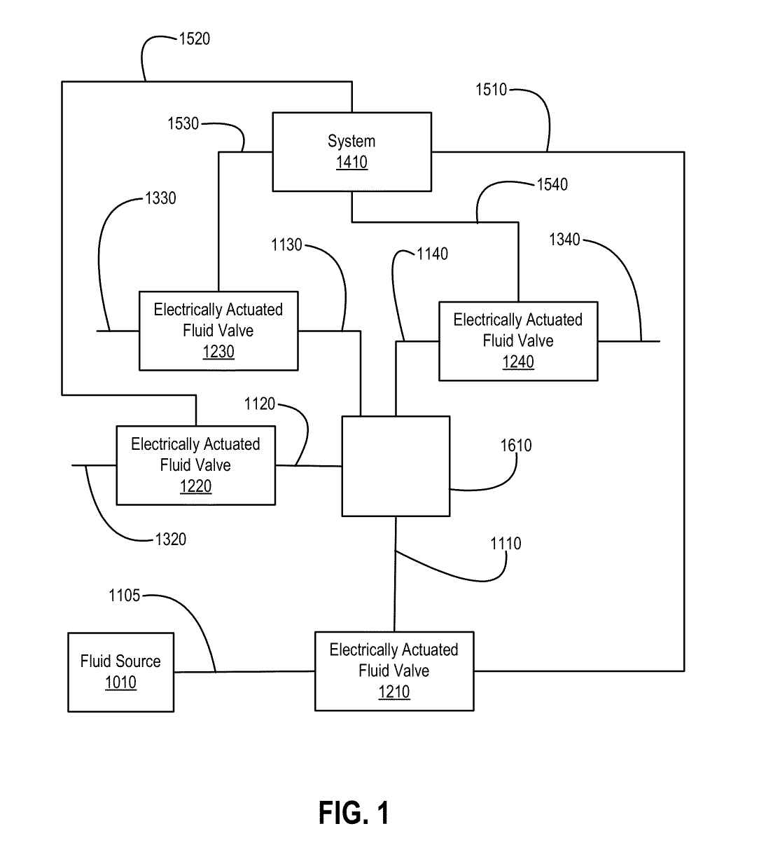

FIG. 1 illustrates an exemplary block diagram of a fluid distribution system, according to one or more embodiments. As shown, an electrically actuated fluid valve 1210 may be coupled to a fluid source 1010 via a fluid coupling device 1105. In one or more embodiments, a fluid coupling device may be or include one or more of a pipe, a tube, a hose, and a conduit that carries fluid, among others.

In one or more embodiments, electrically actuated fluid valve 1210 may control fluid flow to a fluid distribution network 1610. For example, electrically actuated fluid valve 1210 may be or include a master valve. As shown, electrically actuated fluid valve 1210 may be coupled to fluid distribution network 1610 via a fluid coupling device 1110. As illustrated, electrically actuated fluid valves 1220-1240 may be coupled to fluid distribution network 1610 via fluid coupling devices 1120-1140, respectively. In one or more embodiments, electrically actuated fluid valves 1220-1240 may control fluid flow to fluid coupling devices 1320-1340, respectively.

As illustrated, a control system 1410 may be coupled to electrically actuated fluid valves 1210-1240 via respective transmission lines 1510-1540. In one or more embodiments, control system 1410 may control electrically actuated fluid valves 1210-1240 via respective transmission lines 1510-1540. In one example, one or more of transmission lines 1510-1540 may provide one or more signals to respective electrically actuated fluid valves 1210-1240. In another example, one or more of transmission lines 1510-1540 may provide one or more of voltage and current to respective electrically actuated fluid valves 1210-1240.

In one or more embodiments, fluid coupling devices 1320-1340 can be coupled to devices that may further distribute fluid. For example, the fluid may include water, and fluid coupling devices 1320-1340 can be coupled to water sprinkler heads. For instance, fluid source 1010 may include a water supply. In one or more embodiments, system 1410 may control a sprinkler system and/or an irrigation system.

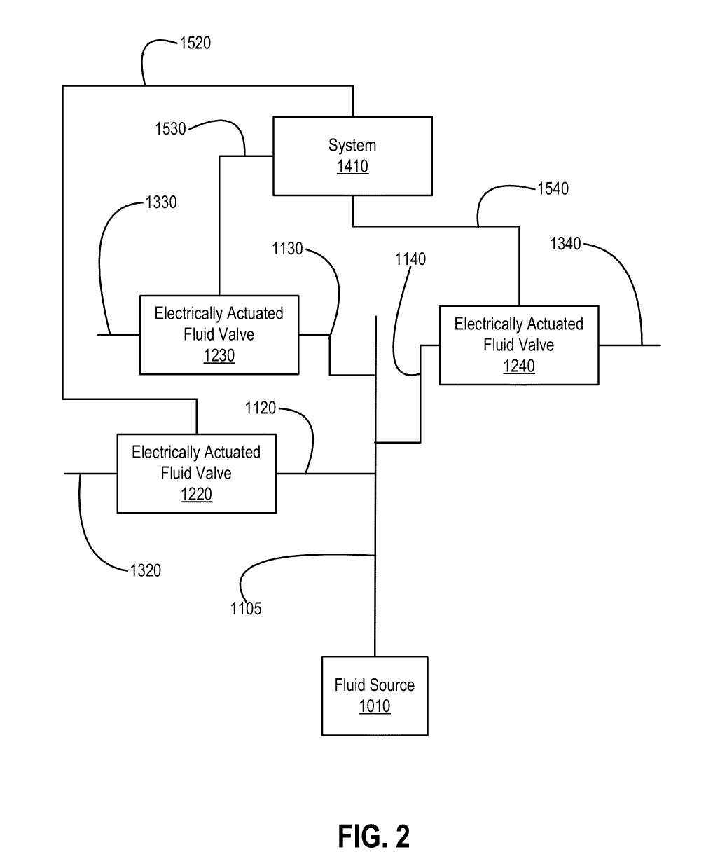

Turning now to FIG. 2, another exemplary block diagram of a fluid distribution system is illustrated, according to one or more embodiments. As shown, fluid source 1010 may be coupled to fluid coupling device 1105. As illustrated, electrically actuated fluid valves 1220-1240 may be coupled, via respective fluid coupling devices 1120-1140, to fluid coupling device 1105.

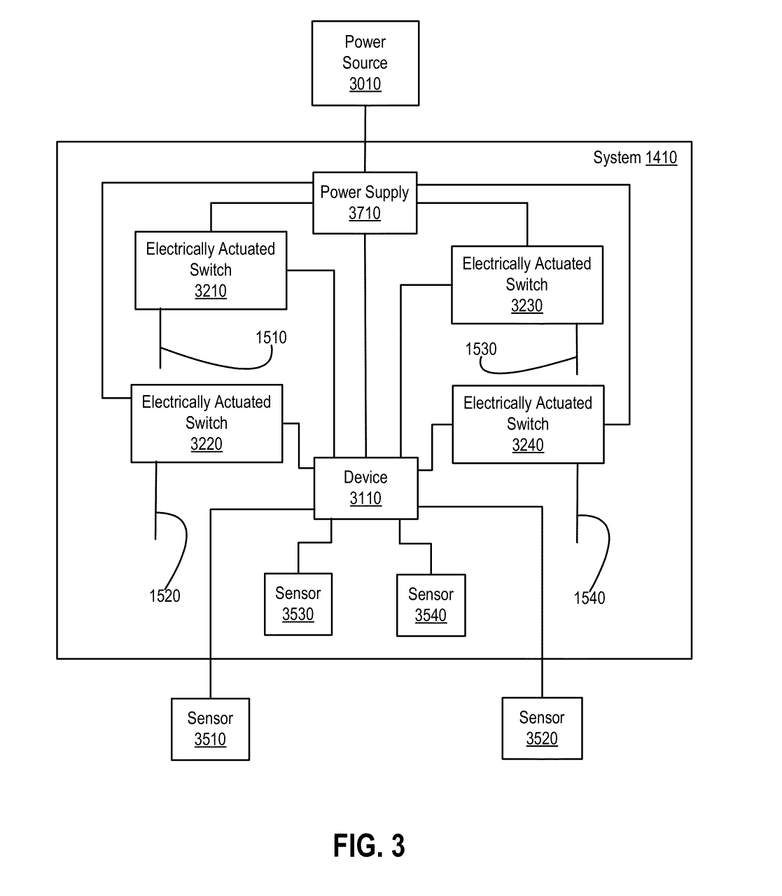

Turning now to FIG. 3, an exemplary system is illustrated, according to one or more embodiments. As shown, system 1410 may be coupled to a power source 3010. In one example, power source 3010 can be or include an alternating current outlet. In another example, power source 3010 can be or include a direct current power supply (e.g., a wall-wart, a switching power supply, etc.). As illustrated, system 1410 may include a power supply 3710 that may be coupled to power source 3010. In one or more embodiments, power supply 3710 may include one or more regulators that may regulate and/or provide one or more of voltage and current to electrical devices and/or electronic devices.

As shown, system 1410 may include one or more electrically actuated switches 3210-3240, a device 3110, and one or more sensors 3530 and 3540. As illustrated, electrically actuated switches 3210-3240 may be coupled to one or more of power supply 3710 and device 3110. As shown, electrically actuated switches 3210-3240 may be coupled to transmission lines 1510-1540, respectively. In one or more embodiments, device 3110 may control one or more electrically actuated fluid valves 1210-1240 via respective electrically actuated switches 3210-3240 and/or respective transmission lines 1510-1540.

In one example, an electrically actuated switch may include an electrically actuated relay that may provide one or more of voltage and current to an electrically actuated fluid valve via a transmission line. In one instance, the relay may include an electrically actuated mechanical relay. In another instance, the relay may include an electrically actuated solid state relay. In a second example, an electrically actuated switch may include an electrically actuated triac that may provide one or more of voltage and current to an electrically actuated fluid valve via a transmission line. In another example, an electrically actuated switch may include an electrically actuated transistor that may provide one or more of voltage and current to an electrically actuated fluid valve via a transmission line. In one instance, the transistor may include a bipolar junction transistor (BJT). In a second instance, the transistor may include a metal oxide semiconductor field effect transistor (MOSFET). In another instance, the transistor may include a junction field effect transistor (JFET).

As illustrated, one or more sensors 3510-3540 may be coupled to device 3110. In one or more embodiments, a sensor may include one or more of a rain sensor, a moisture sensor (e.g., a soil moister sensor), a wind sensor, a light sensor, a humidity sensor (e.g., an atmospheric relative humidity sensor), and a temperature sensor, among others. In one or more embodiments, device 3110 may control one or more of electrically actuated fluid valves 1210-1240 based on one or more inputs and/or one or more readings from one or more of sensors 3510-3540. In another embodiment, device 3110 may control one or more of electrically actuated fluid valves 1210-1240 based on watering restriction information, retrieved from a website of an appropriate municipality, that is based on a location of device 3110.

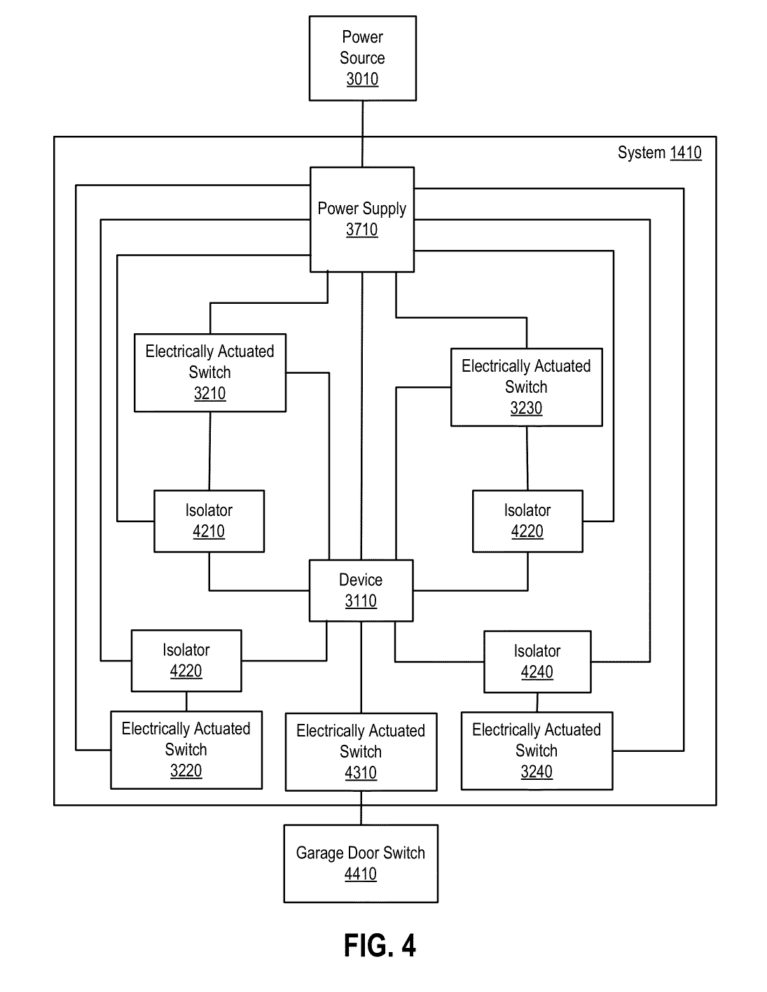

Turning now to FIG. 4, another exemplary system is illustrated, according to one or more embodiments. As shown, system 1410 may include one or more isolators 4210-4240. As illustrated, device 3110 may be coupled to one or more electrically actuated switches 3210-3240 via respective one or more isolators 4210-4240.

In one or more embodiments, a switch (e.g., an electrically actuated switch) may control one or more voltages and/or one or more currents that may damage a device (e.g., device 3110). In one example, a switch may fail, and an isolator may insulate a device from the switch failure. For instance, one or more of switches 3210-3240 may fail, and respective one or more isolators 4210-4240 may protect device 3110. In another example, one or more of isolators 4210-4240 may electrically isolate device 3110 from one or more portions of system 1410 and/or a system that includes system 1410. For instance, one or more portions of system 1410 and/or a system that includes system 1410 may be subject to one or more of switching pulses (e.g., voltage spikes, current spikes, etc.), power supply perturbations, electrostatic discharge, radio frequency transmissions, and lightning, among others, that may disrupt and/or disable device 3110, and one or more of isolators 4210-4240 may protect and/or insulate device 3110 against such disruption and/or disablement.

In one or more embodiments, an isolator may include an opto-isolator. For example, the opto-isolator may couple, in an optical fashion, signaling from device 3110 to other portions of system 1410 and/or from the other portions of system 1410 to device 3110. For instance, the opto-isolator may include a resistive opto-isolator, a opto-isolated triac, a transistor opto-isolator, a diode opto-isolator, and/or an opto-isolated silicon-controlled (SCR) rectifier, among others. In one or more embodiments, an isolator may include one or more of a transformer based isolator and a capacitor-coupled isolator, among others.

As illustrated, an electrically actuated switch 4310 may be coupled to device 3110 and a garage door switch 4410. In one or more embodiments, device 3110 may control garage door switch 4110 via electrically actuated switch 4310.

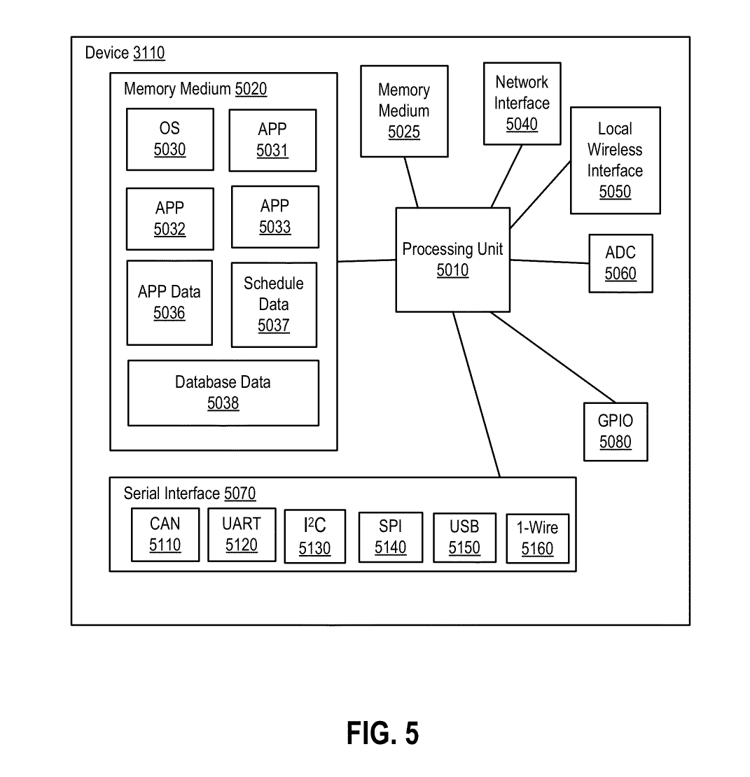

Turning now to FIG. 5, an exemplary block diagram of device 3110 is illustrated, according to one or more embodiments. As shown, device 3110 may include a memory medium 5020 coupled to a processing unit 5010. For example, processing unit 5010 may be or include an applications processor. In one or more embodiments, memory medium 5020 may store data that may be processed by and/or instructions that are executable by processing unit 5010. In one example, memory medium 5020 may store one or more applications (APPs) 5031-5033 and/or an operation system (OS) 5030, among others. For instance, one or more APPs 5031-5033 and/or an OS 5030 may include instructions of an instruction set architecture (ISA) associated with processing unit 5010. In another example, memory medium 5020 may store application (APP) data 5036, schedule data 5037, and database data 5038, among others.

As illustrated, memory medium 5025 may be coupled to processing unit 5010. In one or more embodiments, memory medium 5025 may store data that may be processed by and/or instructions that are executable by processing unit 5010. For example, memory medium 5025 may store one or more of OS 5030, APPs 5031-5033, APP data 5036, schedule data 5037, and database data 5038, among others. For instance, memory medium 5025 may include nonvolatile storage and memory medium 5020 may include volatile storage.

As shown, device 3110 may include a network interface 5040 coupled to processing unit 5010. In one example, network interface 5040 may interface with a wired network, such as a wired Ethernet, a T-1, a DSL (digital subscriber loop) modem, a public switched telephone network (PSTN), or a cable (television) modem, among others. In another example, network interface 5040 can interface with a wireless network, such as a satellite telephone system, a cellular telephone system, or WiMax, among others.

As illustrated, device 3110 may include a local wireless interface 5050 coupled to processing unit 5010. In one example, local wireless interface 5050 may participate in a local wireless network, such as an IEEE (Institute of Electrical and Electronics Engineers) 802.11 network, a WiFi network, a wireless Ethernet network, a Bluetooth network, an IEEE 802.15 network, an IEEE 802.15.4 network, or a ZWave network, among others. In another example, local wireless interface 5050 may host and/or control a local wireless network, such as an IEEE 802.11 network, a WiFi network, a wireless Ethernet network, a Bluetooth network, an IEEE 802.15 network, an IEEE 802.15.4 network, or a ZWave network, among others. In one instance, device 3110 may provide WiFi access point capabilities via local wireless interface 5050. In another instance, device 3110 may provide IEEE 802.15.4 access point capabilities via local wireless interface 5050.

As illustrated, device 3110 may include an analog to digital converter (ADC) 5060 coupled to processing unit 5010. In one or more embodiments, an ADC may convert one or more analog voltage and/or current signals into one or more digital signals. For example, ADC 5060 may be configured to convert voltage signals of a thermistor into digital signals that may be processed by processing unit 5010. As illustrated, device 3110 may include a GPIO (general purpose input/output) 5080 coupled to processing unit 5010. In one or more embodiments, a GPIO may include one or more inputs and/or outputs. For example, GPIO 5080 may be configured and/or utilized in monitoring and/or communicating with devices. In one instance, GPIO 5080 may be configured and/or utilized in monitoring and/or communicating with one or more of sensors 3510-3540 (as illustrated in FIG. 3). In another instance, GPIO 5080 may be configured and/or utilized in monitoring and/or communicating with one or more of electrically actuated fluid valves 1210-1240 (as illustrated in FIG. 1).

As shown, device 3110 may include a serial interface 5070 coupled to processing unit 5010. In one or more embodiments, a serial interface may communicate data with one or more devices in a serial fashion. As illustrated, serial interface 5070 may include one or more serial interfaces, such as one or more of controller area network (CAN) interface 5110, universal asynchronous receiver/transmitter (UART) interface 5120, inter-integrated circuit (I²C) interface 5130, a serial peripheral interconnect (SPI) interface 5140, a universal serial bus (USB) interface 5150, and a 1-Wire interface 5160, among others. In one or more embodiments, serial interface 5070 may be configured and/or utilized to communicate with one or more sensors. For example, one or more of CAN interface 5110, UART interface 5120, I²C interface 5130, SPI interface 5140, USB interface 5150, and 1-Wire interface 5160, among others, may communicate with one or more of sensors 3510-3540 (as illustrated in FIG. 3). In one or more embodiments, GPIO 5080 or one or more portions of GPIO 5080 may be configured to be utilized as and/or to implement one or more of CAN interface 5110, UART interface 5120, I²C interface 5130, SPI interface 5140, USB interface 5150, and 1-Wire interface 5160, among others.

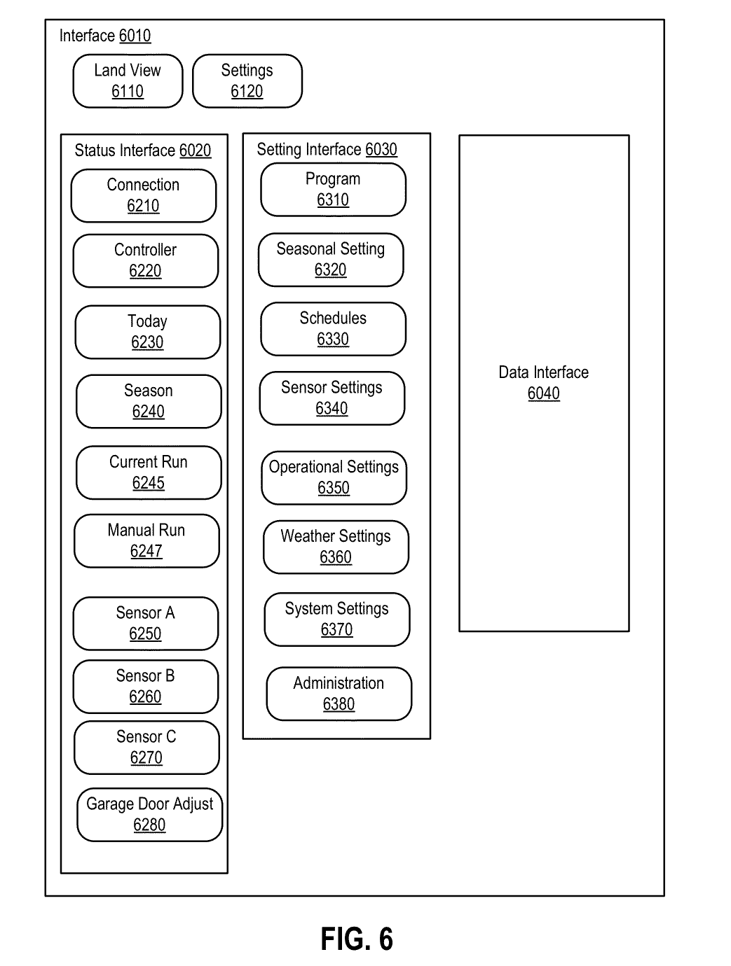

Turning now to FIG. 6, an exemplary user interface is illustrated, according to one or more embodiments. In one or more embodiments, an interface 6010 may be displayed via a display of or coupled to a computing device (e.g., a computer system, a tablet computing device, a smartphone, a wireless telephone, a personal digital assistance, a handheld computing device, a laptop computer, etc.). As illustrated, interface 6010 may provide one or more of a status interface 6020, a setting interface 6030, a data interface 6040, statuses 6210-6270, and buttons and/or icons 6110, 6120, and 6310-6380, among others.

In one example, connection status 6210 may indicate if interface 6010 is communicating with system 1410. For instance, interface 6010 may communicate with system 1410 periodically and/or via a network communication coupling. In a second example, controller status 6220 may indicate a state of system 1410. For instance, a state of system 1410 may include “standby” (e.g., temporarily suspend fluid distribution). In a third example, today status 6230 may indicate a current time of interface 6010. For instance, today status 6230 may be selected and/or actuated by a user, and interface 6010 may synchronize the current time with system 1410. In a fourth example, season status 6240 may indicate a current season that includes a current date. In a fifth example, a current run status 6245 may indicate any scheduled fluid distribution that have run and/or have been executed and/or that will run and/or will be executed. In a sixth example, a manual run status 6247 may be selected and/or actuated by a user to manually permit fluid to flow to one or more zones. For instance, manual run status 6247 may be selected and/or actuated by a user to manually run one or more zones of a water sprinkler system.

In a seventh example, one or more statuses 6250-6270 may indicate statuses of one or more sensors. In one instance, status 6250 may indicate if a rain sensor has been triggered. In another instance, status 6260 may indicate if a garage door is opened. In one or more embodiments, status 6260 may be selected and/or actuated by a user, and system 1410 may close the garage door, if the garage door is open, or may open the garage door, if the garage door is closed. In one or more embodiments, a user may select a garage door adjust button and/or icon 6280, and interface 6010 may provide a menu that may allow the user to adjust a time that system 1410 will close the garage door.

In one or more embodiments, interface 6010 may be displayed via a web browser of a computing device. For example, an APP of APPs 5031-5032 may include a web server that may provide data to implement interface 6010 via a web browser. In one or more embodiments, interface 6010 may be displayed via an application of a computing device. In one example, interface 6010 may be displayed via a smartphone application. In another example, interface 6010 may be displayed via a tablet application.

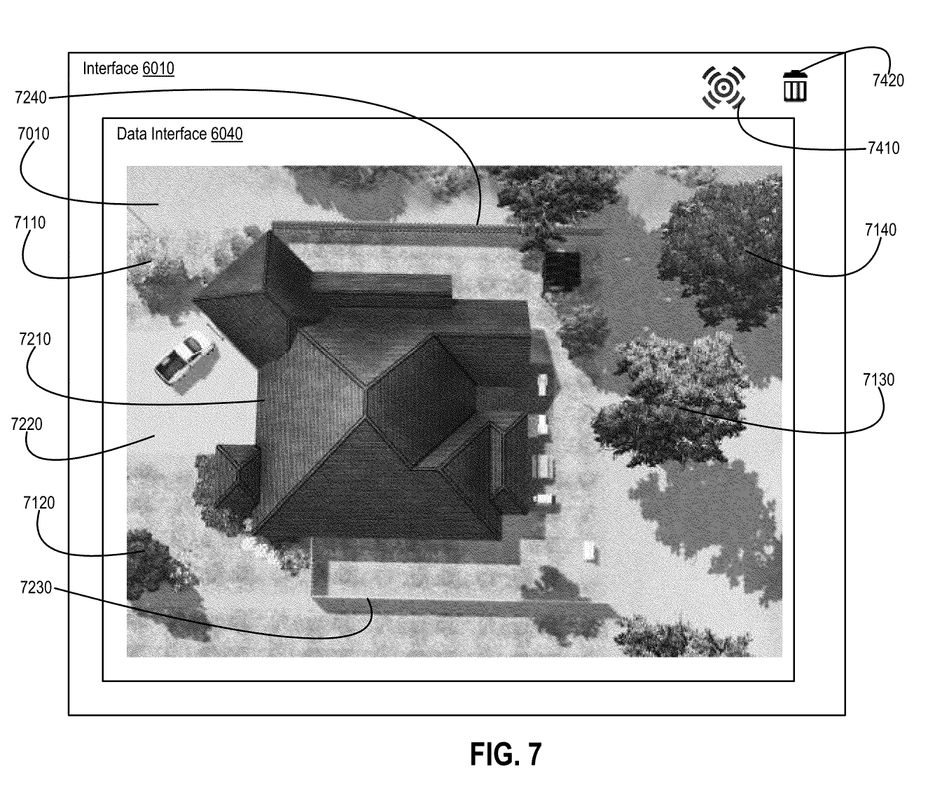

Turning now to FIG. 7, an exemplary view of a data interface 6040 is illustrated, according to one or more embodiments. In one or more embodiments, a user may select button and/or icon 6110, and interface 6010 may provide a view and/or graphical representation 7010 of land. For example, graphical representation 7010 may provide a view and/or graphical representation of real estate. For instance, graphical representation 7010 may be or include an aerial and/or satellite picture of real estate. As shown, view and/or graphical representation 7010 may include one or more plants 7110-7140 (e.g., shrubs, flowers, trees, etc.) and/or one or more structures 7210-7240 (e.g., building(s), drive way(s), fence(s), pool(s), etc.).

In one or more embodiments, interface 6010 may provide one or more of a zone icon and/or button 7410 and a disposal button and/or icon 7420, among others. In one example, zone icon and/or button 7410 may be selected and/or utilized by a user to obtain a new fluid distribution zone. For instance, the user may drag and drop zone icon and/or button 7410 to a location included in data interface 6040. In another example, disposal icon and/or button 7420 may be selected and/or utilized by a user to dispose of a zone. For instance, the user may drag and drop a zone icon and/or button from data interface 6040 to disposal icon and/or button 7420.

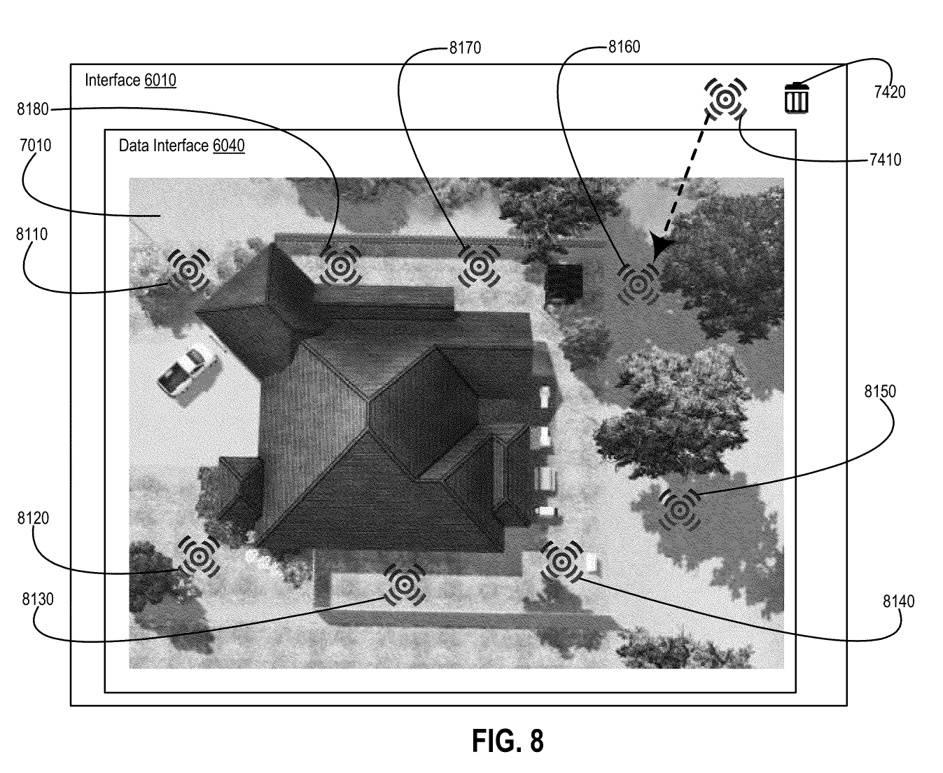

Turning now to FIGS. 8 and 9, exemplary views of a data interface that displays one or more zones are illustrated, according to one or more embodiments. As shown in FIG. 8, data interface 6040 may display one or more zone icons 8110-8180. In one or more embodiments, a zone may include one or more fluid distribution devices. For example, the fluid may include water, and the one or more fluid distribution devices of the zone may include one or more water sprinkler devices.

As illustrated, zone and/or button icon 7410 may be dragged to a location of data interface 6040 to create and/or implement a new zone configuration that may be represented via zone icon 8160. As shown in FIG. 9, zone icon 8150 may be dragged to disposal icon 7420 to dispose of and/or delete one or more of zone icon 8150 and a zone configuration associated with zone icon 8150.

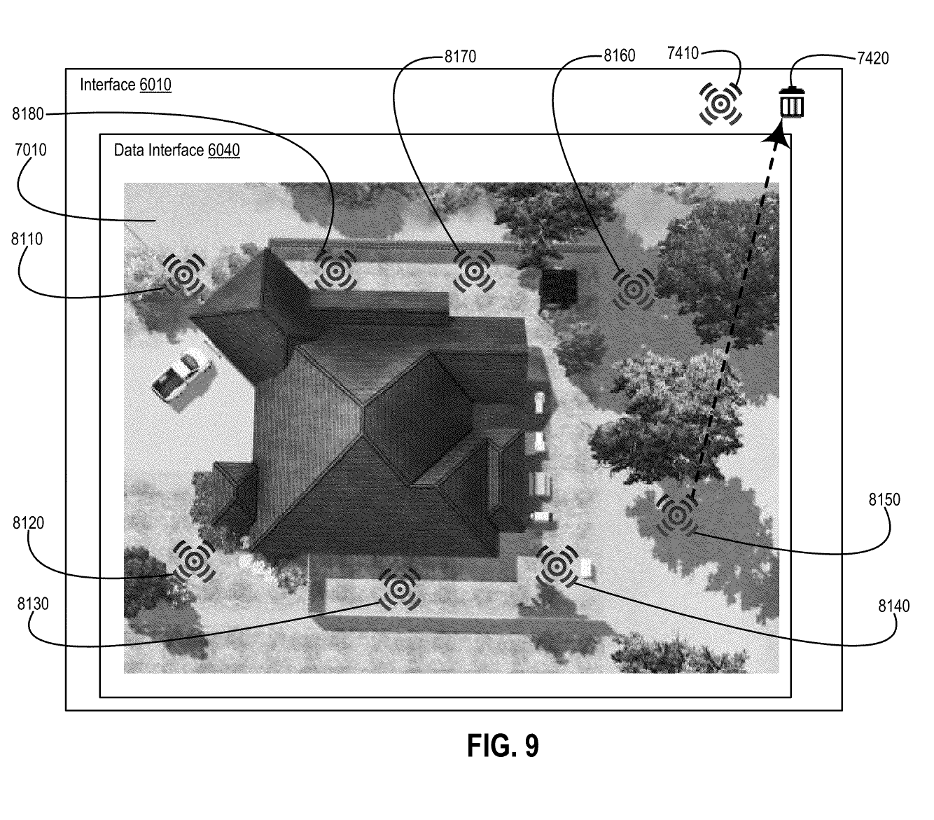

Turning now to FIG. 10, an exemplary zone control menu is illustrated, according to one or more embodiments. As shown, a zone control menu 10010 may be provided via data interface 6040. In one or more embodiments, zone control menu 10010 may be provided in response to a user selecting a zone icon. For example, a user may click or double clicking zone icon 8130, and zone control menu 10010 may be provided in response to the user clicking or double clicking zone icon 8130.

As illustrated, zone control menu 10010 may display a name of a zone associated with a zone (e.g., a zone associated with zone icon 8130). In one or more embodiments, the name of the zone associated with the zone icon may be entered and/or changed via zone control menu 10010. In one example, “Zone 3” may have been entered via zone control menu 10010. In another example, “Zone 3” may be changed to “South Central Yard”. As shown, zone control menu 10010 may display an active status. In one or more embodiments, an active status can be changed via zone control menu 10010. As illustrated, an active status of a zone associated with zone icon 8130 includes an affirmative status, and the active status of the zone associated with zone icon 8130 may be changed to a negative status.

As shown, a zone associated with zone icon 8130 may be manually initialized to permit fluid to flow for an amount of time transpiring. For instance, zone control menu 10010 may receive an amount of time to permit fluid to flow. As illustrated, for example, an amount of time, such as “10” minutes, may be received from a user via zone control menu 10010. As shown, zone control menu 10010 may include one or more of buttons and/or icons 10110 and 10120. In one example, any change may be confirmed via button and/or icon 10110. For instance, user input indicating confirmation may include the user selecting and/or actuating “OK” button and/or icon 10110. In another example, any change may be discarded via button and/or icon 10120. For instance, user input indicating confirmation may include the user selecting and/or actuating “Cancel” button and/or icon 10120. In one or more embodiments, one or more structures and/or functionalities described with reference to a zone associated with zone icon 8130, zone icon 8130, and zone control menu 10010 may be included in and/or associated with one or more other zones associated with respective one or more zone icons associated with respective one or more zone control menus.

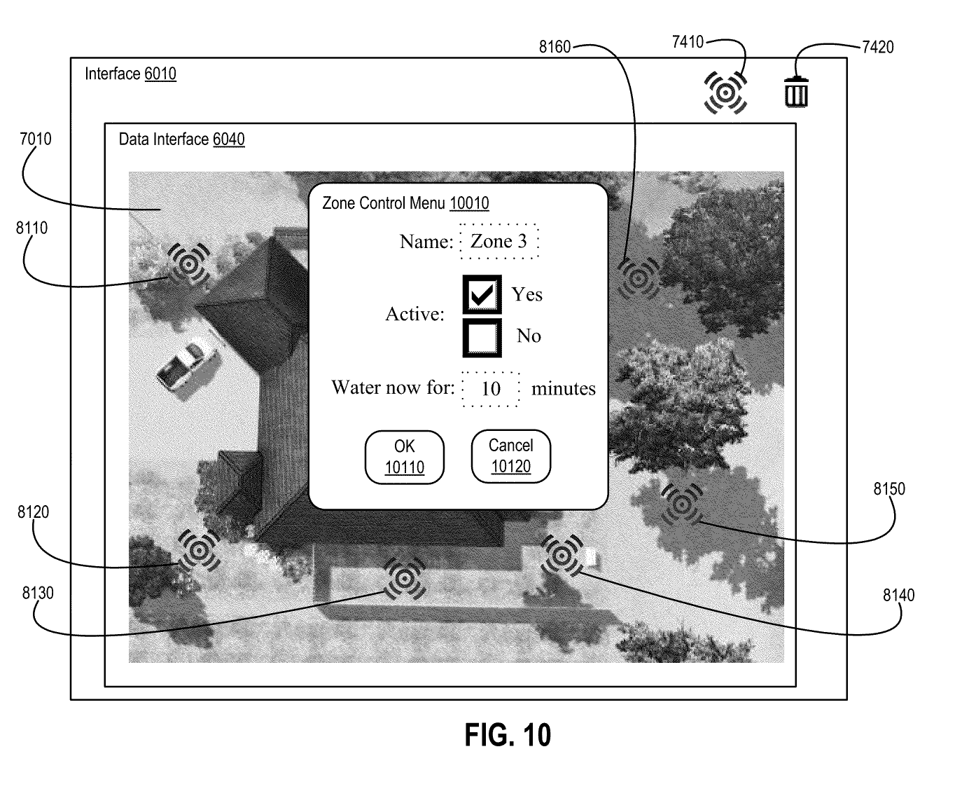

Turning now to FIG. 11, an exemplary program interface is illustrated, according to one or more embodiments. As shown, “Program” button and/or icon 6310 may be selected and/or actuated by a user via interface 6010 and/or setting interface 6030. As illustrated, data interface 6040 may display a program. In one or more embodiments, data interface 6040 may display and/or receive a program name (e.g., “July Program”) via an input area 11205 and one or more zone names associated with respective one or more amount of time to permit fluid flow. For example zone names “Zone 1”, “Zone 2”, “Zone 3”, “Zone 4”, “Zone 5”, “Zone 6”, “Zone 7”, and “Zone 8” may correspond to respective zone icons 8110-8180 (as shown in FIG. 8) and/or may correspond to respective zones of a water sprinkler system.

In one or more embodiments, a user may input an amount of time that system 1410 may permit fluid to flow. For example, the user may input minutes that system 1410 may permit water to flow via each zone in a water sprinkler system. In one or more embodiments, data interface 6040 may include one or more increment/decrement elements 11210-11280 that can be selected and/or actuated by a user to increment and/or decrement an amount of time to and/or from an amount of time that that system 1410 may permit fluid to flow. In one example, the user may select and/or actuate a top portion of increment/decrement element 11210 to add a minute to an amount of time that system 1410 permits water to flow a zone in a water sprinkler system associated with the name “Zone 1”. In another example, the user may select and/or actuate a bottom portion of increment/decrement element 11220 to subtract a minute to an amount of time that system 1410 permits water to flow a zone in a water sprinkler system associated with the name “Zone 2”.

In one or more embodiments, one or more buttons and/or icons 11110-11140 may be displayed and/or selected by a user to, respectively, create a new program, delete a program, save a program, and cancel changes to a program. In one or more embodiments, one or more buttons and/or icons 11150 and 11160 may be displayed and/or selected by a user to select a different program.

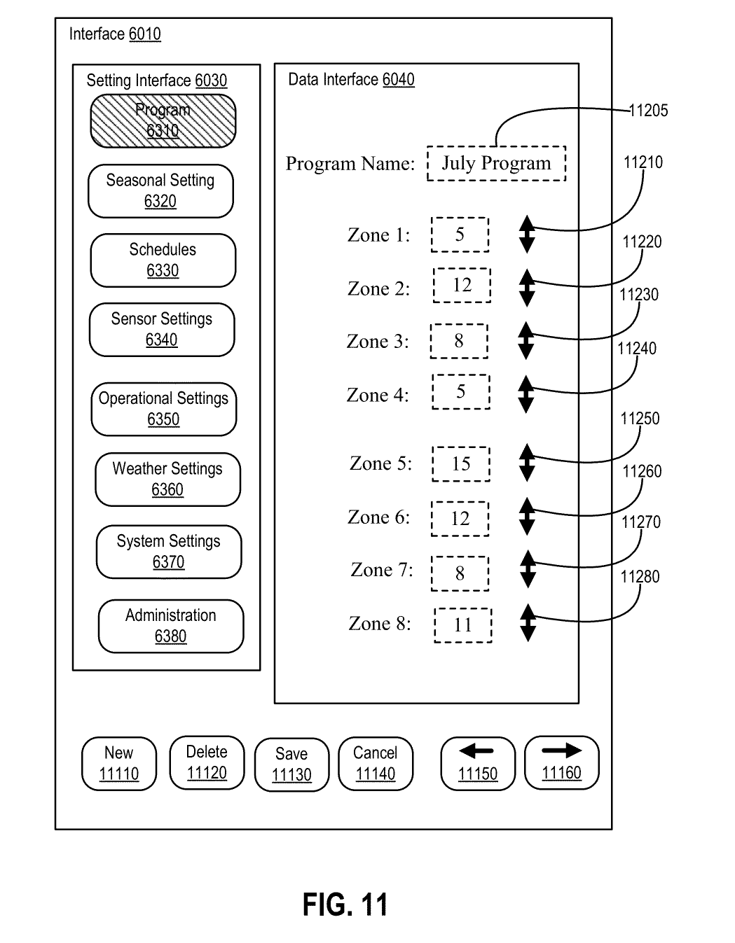

Turning now to FIG. 12, an exemplary seasonal setting interface is illustrated, according to one or more embodiments. As shown, “Seasonal Setting” button and/or icon 6320 may be selected and/or actuated by a user via interface 6010 and/or setting interface 6030. As illustrated, data interface 6040 may display a season program interface. In one or more embodiments, a season name, a “from date”, a “to date”, and/or a percentage may be displayed, entered, and/or modified via data interface 6040. As shown, the season name (e.g., “Spring”), the “from date” (e.g., “March 1”), the “to date” (e.g., “June 1”), and/or the percentage (e.g., “65”) may be displayed, entered, and/or modified via respective input areas 12210-12240. As illustrated, a percentage may be entered and/or modified directly, and/or a percentage may be entered and/or modified via a slider 12250.

In one or more embodiments, a percentage corresponding to a period of time (e.g., a season) may be applied to all programs during the period of time. For example, a program may include a zone watering a portion of a lawn for ten minutes with a sixty-five percent seasonal setting, such that system 1410 permits the zone watering the portion of the lawn for six and one half minutes. For instance, during a spring season, there may be more rainfall, and a fractional reduction in a lawn and/or garden watering schedule and/or amount may be applicable. In one or more embodiments, one or more systems, methods, and/or processes described herein may be configured such that a percentage corresponding to a period of time (e.g., a season) may exceed one hundred percent.

In one or more embodiments, one or more buttons and/or icons 12110-12140 may be displayed and/or selected by a user to, respectively, create a new a new season, delete a season, save a season, and cancel changes to a season. In one or more embodiments, one or more buttons and/or icons 12150 and 12160 may be displayed and/or selected by a user to select a different season.

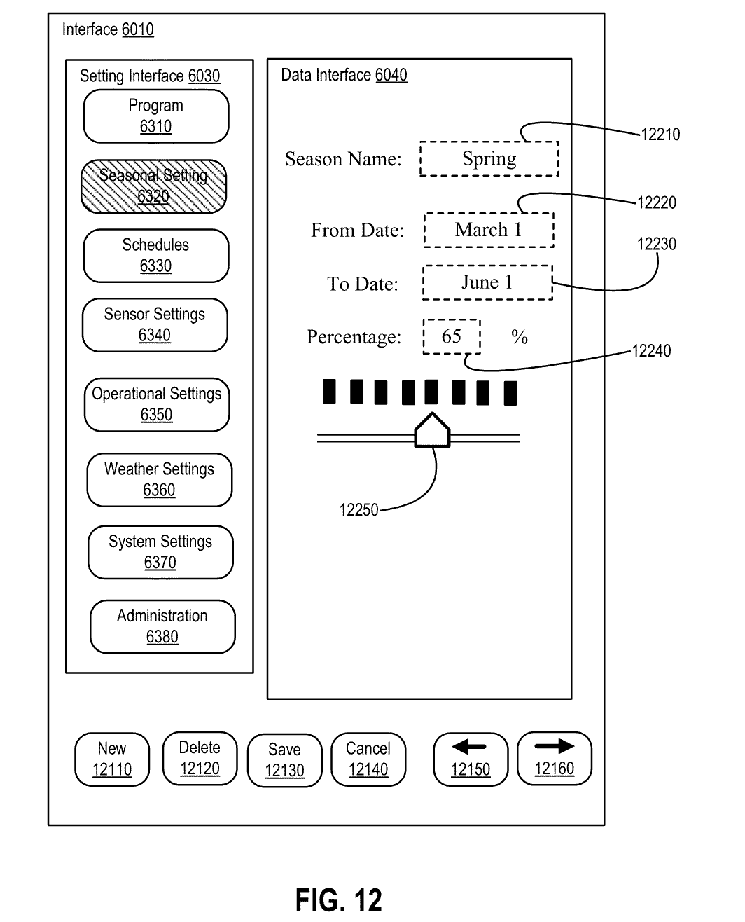

Turning now to FIG. 13, an exemplary schedules interface is illustrated, according to one or more embodiments. As shown, “Schedules” button and/or icon 6330 may be selected and/or actuated by a user via interface 6010 and/or setting interface 6030. As illustrated, data interface 6040 may display a schedules interface.

As shown, a user may input and/or modify one or more of a schedule name and a start time, among others, via respective input areas 13210 and 13220. As illustrated, a user may select one or more of a program, a season, and an active status via respective one or more drop down menus 13230-13250. As shown, a user may select one or more days of a week. For example, a user may select “Odd Days” and “Sunday”. For instance, days of a week may be enumerated with “Monday” as a first day of the week.

In one or more embodiments, one or more buttons and/or icons 13110-13140 may be displayed and/or selected by a user to, respectively, create a new a new schedule, delete a schedule, save a schedule, and cancel changes to a schedule. In one or more embodiments, one or more buttons and/or icons 13150 and 13160 may be displayed and/or selected by a user to select a different schedule.

In one or more embodiments, a checkbox associated with “Skip X Day(s)” may be selected by a user, and a dropdown menu 13260 may be utilized by the user to select a number of days, where the number of days is “X”. For example, the user may utilized this feature to skip a number of days between a water distribution program.

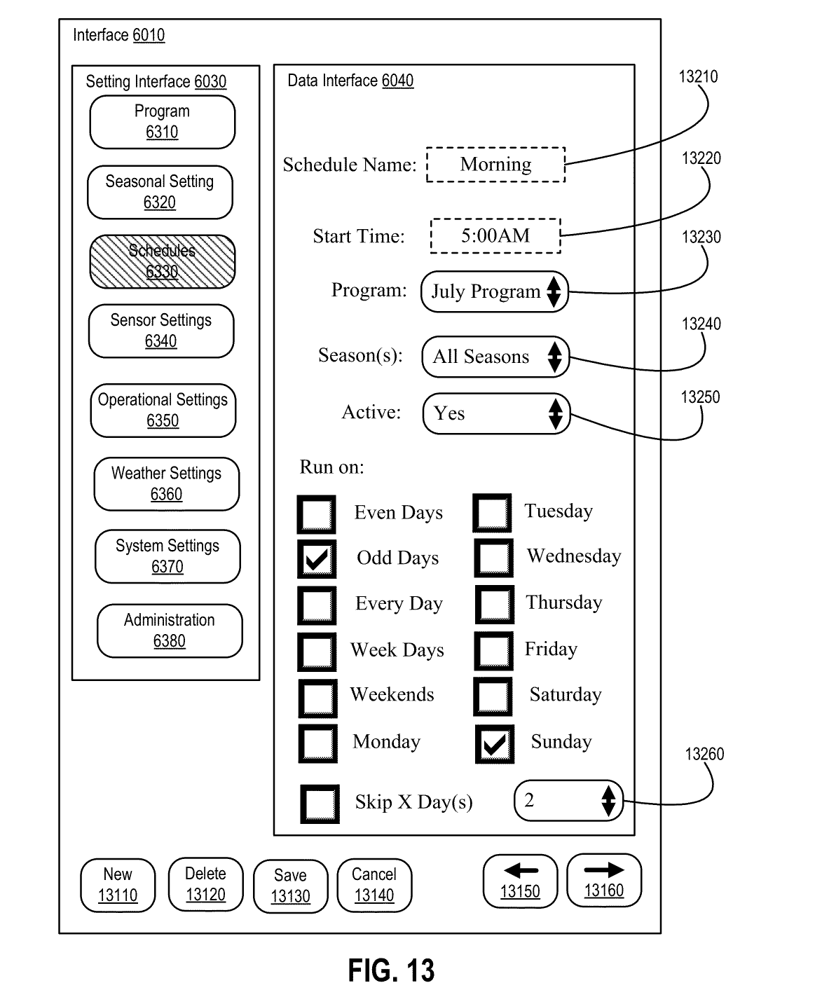

Turning now to FIG. 14, an exemplary sensor settings interface is illustrated, according to one or more embodiments. As shown, “Sensor Settings” button and/or icon 6340 may be selected and/or actuated by a user via interface 6010 and/or setting interface 6030. As illustrated, data interface 6040 may display a sensor settings interface. As illustrated, a dropdown menu 14210 may be utilized to display a presence of a rain sensor and/or may be utilized to select if a rain sensor is present. As shown, check boxes 14220 and 14230 may be utilized to indicate and/or select if a rain sensor is normally open or normally closed.

In one or more embodiments, system 1410 may interface with an automated garage door system. As illustrated, a dropdown menu 14240 may be utilized to display a presence of a garage door sensor and/or may be utilized to select if a presence of a garage door sensor is present. As shown, a dropdown menu 14250 may be utilized in selecting a number of minutes transpiring to close the garage door, if the garage door is open. In one or more embodiments, checkbox 14260 may be utilized in determining if this feature is utilized. As illustrated, text interface 14270 may be utilized to close a garage door at a specific time, if the garage door is open. In one or more embodiments, checkbox 14280 may be utilized in determining if this feature is utilized. As shown, one or more buttons and/or icons 14110 and 14120 may be displayed and/or selected by a user to, respectively, save one or more settings, and cancel changes to one or more settings.

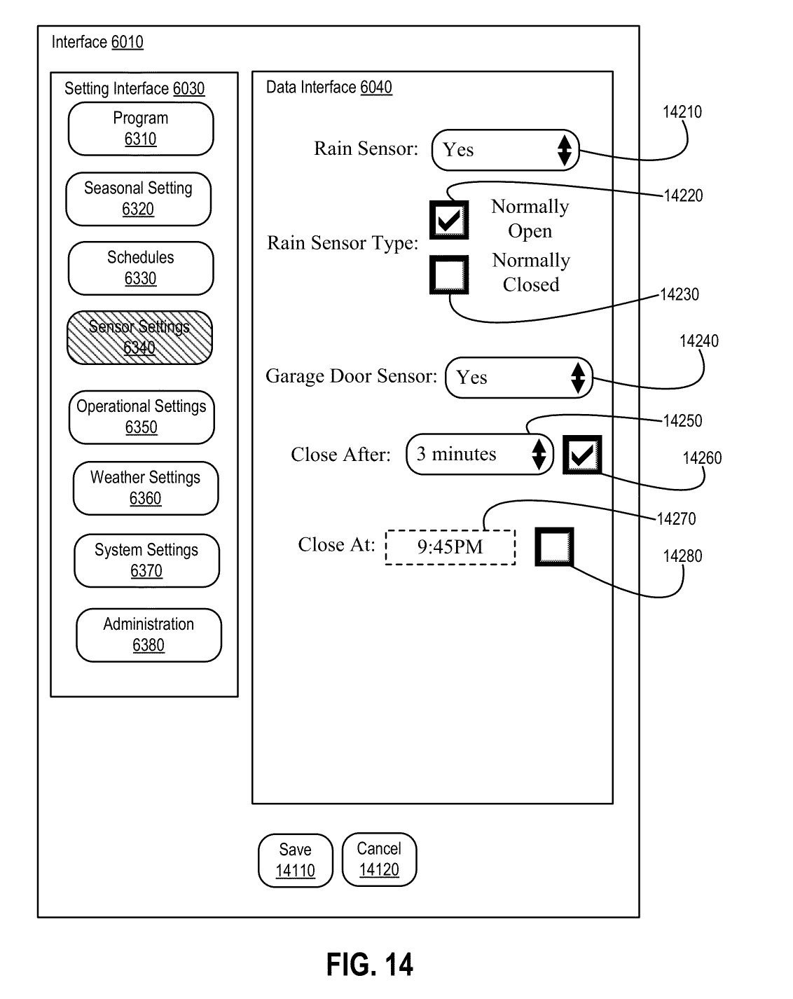

Turning now to FIG. 15, an exemplary operational settings interface is illustrated, according to one or more embodiments. As shown, “Operational Settings” button and/or icon 6350 may be selected and/or actuated by a user via interface 6010 and/or setting interface 6030. As illustrated, data interface 6040 may display an operational settings interface. As illustrated, a dropdown menu 15210 may be utilized to display a bypass state of a rain sensor and/or may be utilized to select if a rain sensor is to be bypassed. As shown, a dropdown menu 15220 may be utilized to indicate and/or select if a master valve is present. As illustrated, dropdown menu 15230 may be utilized to select an amount of time (e.g., days) to transpire to delay a fluid distribution schedule.

In one or more embodiments, a reference graphic may be utilized. For example, graphical representation 7010 of land as illustrated in FIG. 7 may be utilized. As shown, an input area 15240 may be utilized to provide a location (e.g., a disk location, a network location, etc.) of the reference graphic. In one or more embodiments, a location of a reference graphic may include an URI (uniform resource identifier) and/or an URL (universal resource locator). In one example, a location of a reference graphic may include “http://bluespray.net/lawns/lawn2.jpg”. In a second example, a location of a reference graphic may include “ftp://bluespray.net/lawns/lawn4.jpg”. In a third example, a location of a reference graphic may include “file://c/users/fred/myhouse.png”. In another example, a location of a reference graphic may include “C:\users\jane\myranch.png”.

As shown, an input area 15250 may display and/or receive input of a location of a reference graphic. As illustrated, a file selection button and/or icon 15260 may be selected and/or actuated by a user. For example, the user may select a file that includes the reference graphic from a file menu that may be displayed in response to the user selecting and/or actuating file selection button and/or icon 15260. As shown, one or more buttons and/or icons 15110 and 15120 may be displayed and/or selected by a user to, respectively, save one or more settings, and cancel changes to one or more settings.

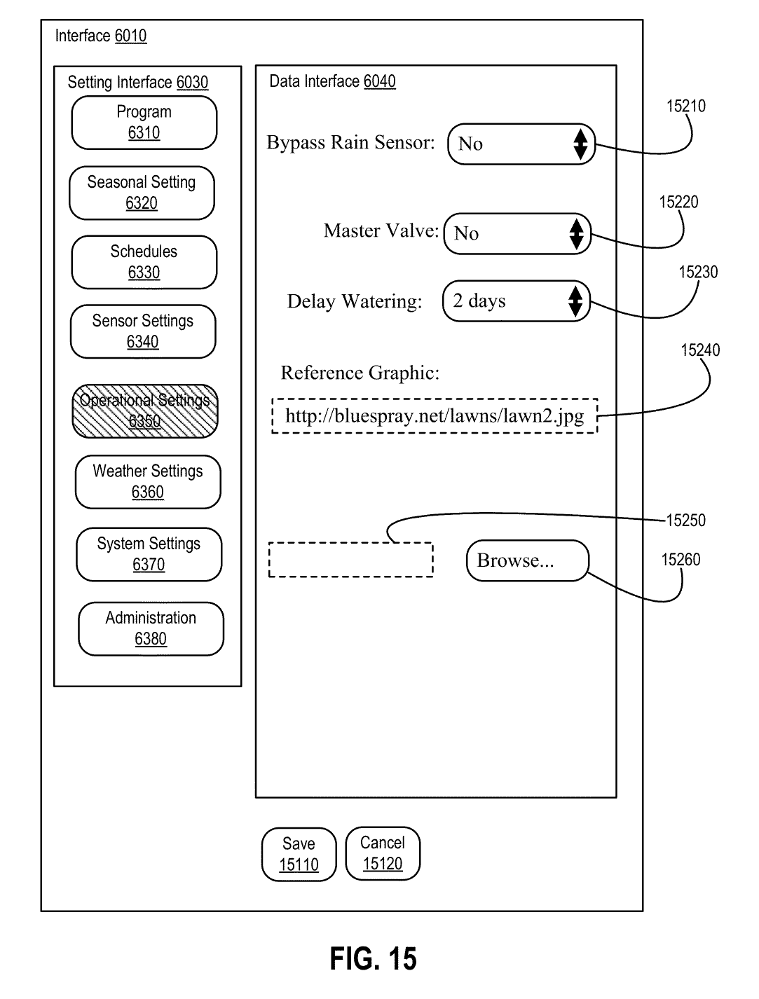

Turning now to FIG. 16, an exemplary weather settings interface is illustrated, according to one or more embodiments. As shown, “Weather Settings” button and/or icon 6360 may be selected and/or actuated by a user via interface 6010 and/or setting interface 6030. As illustrated, data interface 6040 may display a weather settings interface. As illustrated, a dropdown menu 16210 may be utilized to display and/or configure an amount of time in a future that predicted weather data may be utilized.

In one or more embodiments, one or more criteria may be utilized to postpone and/or cancel a scheduled fluid distribution. For example, one or more criteria may be utilized to postpone and/or cancel a scheduled watering of one or more of a lawn and a garden, among others. For instance, a scheduled watering of one or more of a lawn and a garden, among others, may be based on if a chance of rain meets and/or exceeds a first threshold, if a temperature is at or below a second threshold, and/or if a wind speed meets and/or exceeds a third threshold, among others.

As illustrated, a dropdown menu 16220 may be utilized to indicate and/or select if a scheduled watering of one or more of a lawn and a garden, among others, is to be canceled if a chance of rain meets and/or exceeds sixty percent. As shown, a dropdown menu 16230 may be utilized to indicate and/or select if a scheduled watering of one or more of a lawn and a garden, among others, is to be canceled if an outside temperature is at or below thirty-four degrees Fahrenheit. As illustrated, a dropdown menu 16240 may be utilized to indicate and/or select if a scheduled watering of one or more of a lawn and a garden, among others, is to be canceled if a wind speed (e.g., a sustained wind speed, a gust wind speed, etc.) meets and/or exceeds twenty miles per hour (MPH). As shown, one or more buttons and/or icons 16110 and 16120 may be displayed and/or selected by a user to, respectively, save one or more settings, and cancel changes to one or more settings.

In one or more embodiments, one or more criteria may be utilized to postpone and/or cancel a scheduled watering of one or more of a lawn and a garden, among others, may be obtained via a communicatively coupled computer system. For example, system 1410 may be coupled to the communicatively coupled computer system via a network, and system 1410 may obtain the one or more criteria via the network. For instance, the network may include an Internet. As illustrated, input area 16250 may be utilized to indicate and/or input a location that may be provided to the communicatively coupled computer system, and the one or more criteria may be based on the location. For example, the location may include a location identification. For instance, the location identification can include one or more of zip code, a city name, a state name, a neighborhood name, a latitude measurement, a longitude measurement, an airport name, and an airport code, among others.

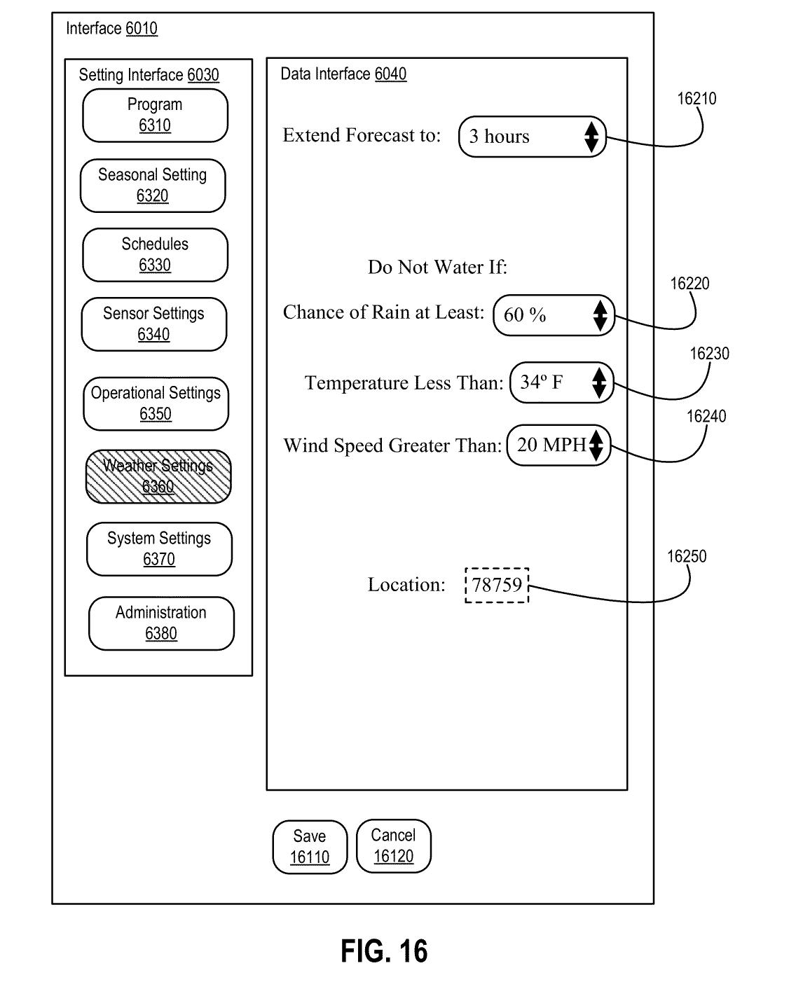

Turning now to FIG. 17, an exemplary system settings interface is illustrated, according to one or more embodiments. As shown, “System Settings” button and/or icon 6370 may be selected and/or actuated by a user via interface 6010 and/or setting interface 6030. As illustrated, data interface 6040 may display a system settings interface.

As shown, a dropdown menu 17210 may be utilized to display and/or configure a wireless mode of wireless communication that may be utilized. In one or more embodiments, a wireless mode of communication may include one or more of an access point mode, a master mode, an ad-hoc mode, an infrastructure mode, and a client mode, among others. In one example, local wireless interface 5050 (as illustrated in FIG. 5) may be utilized in providing wireless access point functionality. For instance, system 1410 may function as a wireless access point and may allow WiFi clients to communicate with system 1410 via local wireless interface 5050. In a second example, local wireless interface 5050 (as illustrated in FIG. 5) may be utilized in communicating with an access point. For instance, system 1410 may join and/or communicate with an existing WiFi network, and WiFi clients may communicate with system 1410 via the access point and local wireless interface 5050. In another example, local wireless interface 5050 (as illustrated in FIG. 5) may be utilized in providing ad-hoc wireless communication functionality. For instance, system 1410 may join and/or initiate an ad-hoc WiFi network, and WiFi clients can communicate with system 1410 via local wireless interface 5050.

As illustrated, a service set identifier (SSID) may be displayed and/or received via input area 17220. As shown, a user may select and/or actuate a search button and/or icon 17225, and system 1410 may scan for one or more service set identifiers (SSIDs). In one or more embodiments, device 3110 may scan for one or more SSIDs, and display one or more SSIDs via interface 6010. For example, a user may select one of the one or more SSIDs that were discovered via the scan for one or more SSIDs. For instance, the user may select a SSID that corresponds to the user's home WiFi network.

In one or more embodiments, system 1410 may be configured to provide wireless access point functionality. For example, system 1410 may be configured to provide wireless access point functionality out-of-the-box. In one instance, a user may utilize the wireless access point functionality, provided by system 1410 out-of-the-box, to initially configure system 1410. In another instance, a SSID (e.g., a default SSID, such as “Bluespray”) may be provided via one or more of printing the SSID on the box and printing the SSID in a user's manual, among others.

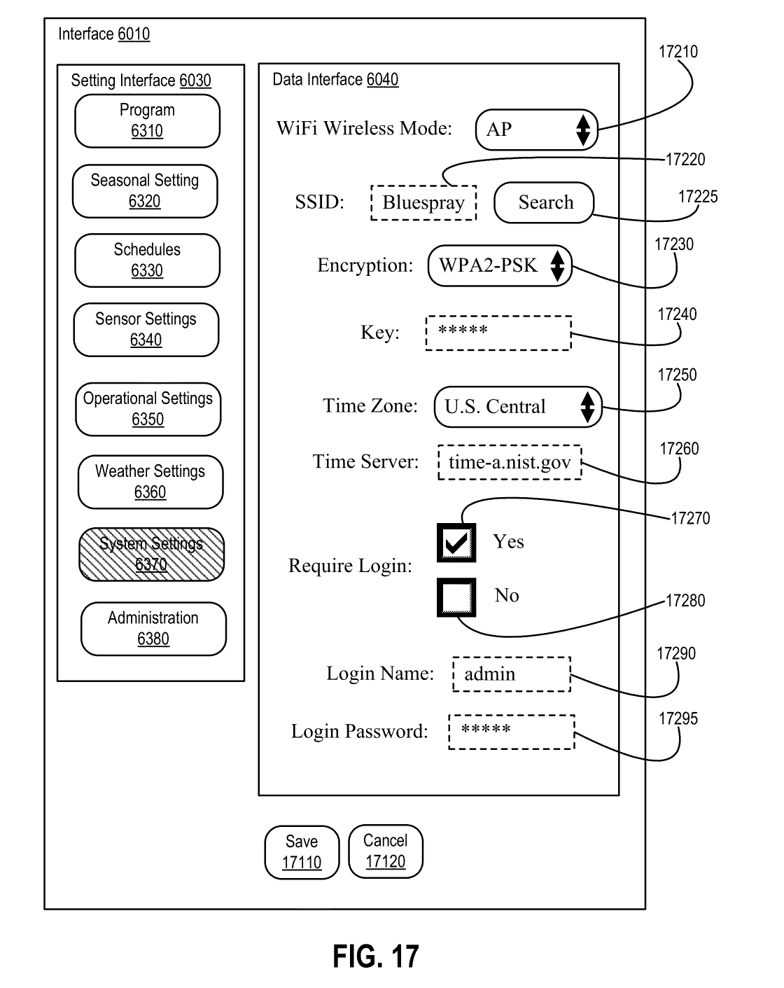

As illustrated in FIG. 18, the user may select, via an access point search menu 18010, one of the one or more SSIDs that were discovered via the scan for one or more SSIDs. As illustrated, the user may select and/or actuate a button and/or icon 18510 to confirm a selection or may select and/or actuate a button and/or icon 18520 to cancel a selection. In one or more embodiments, local wireless interface 5050 (as illustrated in FIG. 5) may be utilized in providing ad-hoc WiFi functionality and/or WiFi access point functionality to a client while providing, to the client, the one or more SSIDs that were discovered via the scan for one or more SSIDs. For example, a client may utilize system 1410 as a WiFi access point while selecting a SSID of the one or more SSIDs that were discovered via the scan for one or more SSIDs.

As shown in FIG. 17, a dropdown menu 17230 may be utilized to display and/or configure a wireless mode of encryption that may be utilized. In one or more embodiments, a wireless mode of encryption can include one or more of wired equivalent privacy (WEP), WiFi protected access (WPA), WPA phase shift key (WPA-PSK), WPA2, WPA2 phase shift key (WPA2-PSK), WPA-PSK/WPA2-PSK, and an advanced encryption standard (AES), among others. As illustrated, a key may be entered via an input area 17240.

As shown, a dropdown menu 17250 may be utilized to display and/or configure a time zone that may be utilized. As illustrated, a time server may be displayed and/or entered via an input area 17260. In one or more embodiments, a login may be required to access system 1410. As shown, checkboxes 17270 and 17280 may be utilized to display and/or enter whether or not a login (e.g., a username and/or a password) is required to access system 1410. As shown, a login name may be displayed and/or entered via an input area 17290, and a password may be entered via an input area 17295. As illustrated, one or more buttons and/or icons 17110 and 17120 may be displayed and/or selected by a user to, respectively, save one or more settings, and cancel changes to one or more settings.

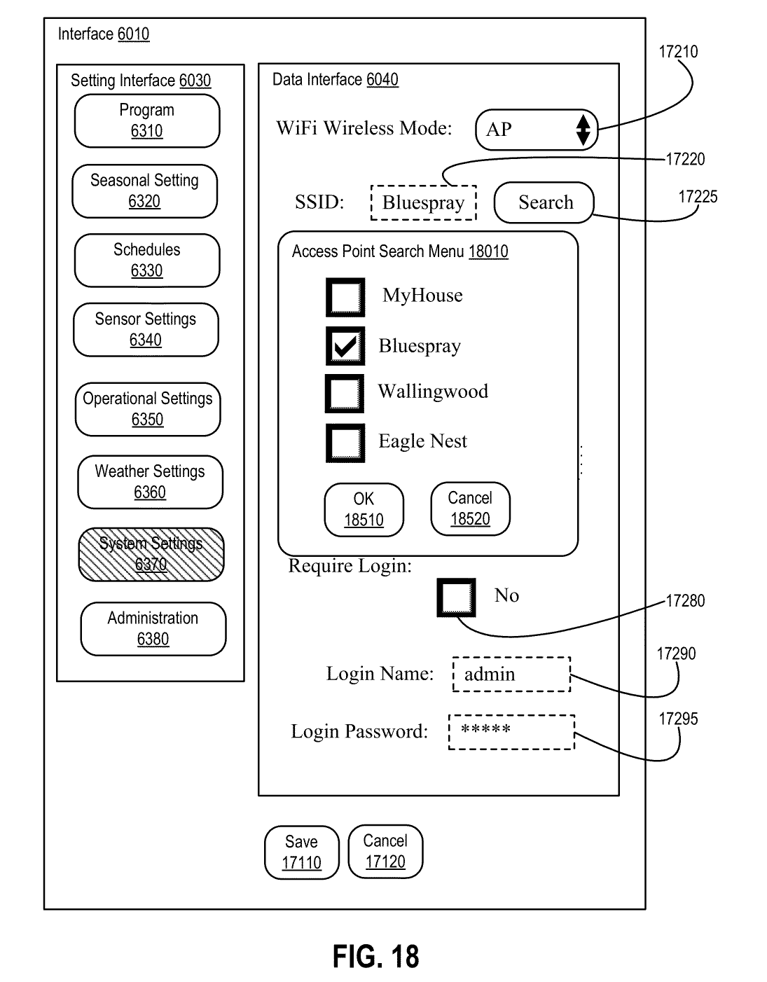

Turning now to FIG. 19, an exemplary administration interface is illustrated, according to one or more embodiments. As shown, “Administration” button and/or icon 6380 may be selected and/or actuated by a user via interface 6010 and/or setting interface 6030. As illustrated, data interface 6040 may display an administration interface. As illustrated, an input area 19210 may display and/or receive input of a location of a backup. In one or more embodiments, a backup may include data that system 1410 may utilize in performing functions according to one or more configurations. In one example, the backup may include one or more of (as illustrated in FIG. 5) APP data 5036, schedule data 5037, and database data 5038, among others. In another example, the backup may include one or more portions of APP data 5036, schedule data 5037, and/or database data 5038, among others.

As shown, a file selection button and/or icon 19220 may be selected and/or actuated by a user. For example, the user may select a file that includes the backup from a file menu that may be displayed in response to the user selecting and/or actuating file selection button and/or icon 19220. As illustrated, the user may select and/or actuate a button and/or icon 19230 to restore (e.g., upload) a backup. As shown, the user may select and/or actuate a button and/or icon 19240 to cancel restoring (e.g., uploading) a backup. As illustrated, the user may select and/or actuate a button and/or icon 19250 to retrieve and/or save (e.g., download) a backup.

In one or more embodiments, firmware of system 1410 may be updated. In one example, the firmware may include one or more of (as illustrated in FIG. 5) OS 5030 and APPs 5031-5033, among others. In another example, the firmware may include one or more of portions of OS 5030, APP 5031, APP 5032, and/or APP 5033, among others.

As shown, an input area 19260 may display and/or receive input of a location of a firmware update. As illustrated, a file selection button and/or icon 19270 may be selected and/or actuated by a user. For example, the user may select a file that includes the firmware update from a file menu that may be displayed in response to the user selecting and/or actuating file selection button and/or icon 19270. As shown, the user may select and/or actuate a button and/or icon 19280 to update (e.g., upload) firmware. As shown, the user may select and/or actuate a button and/or icon 19290 to cancel updating (e.g., uploading) firmware. In one or more embodiments, the user may select and/or actuate a button and/or icon 19110 to restart device 3110 and/or system 1410.

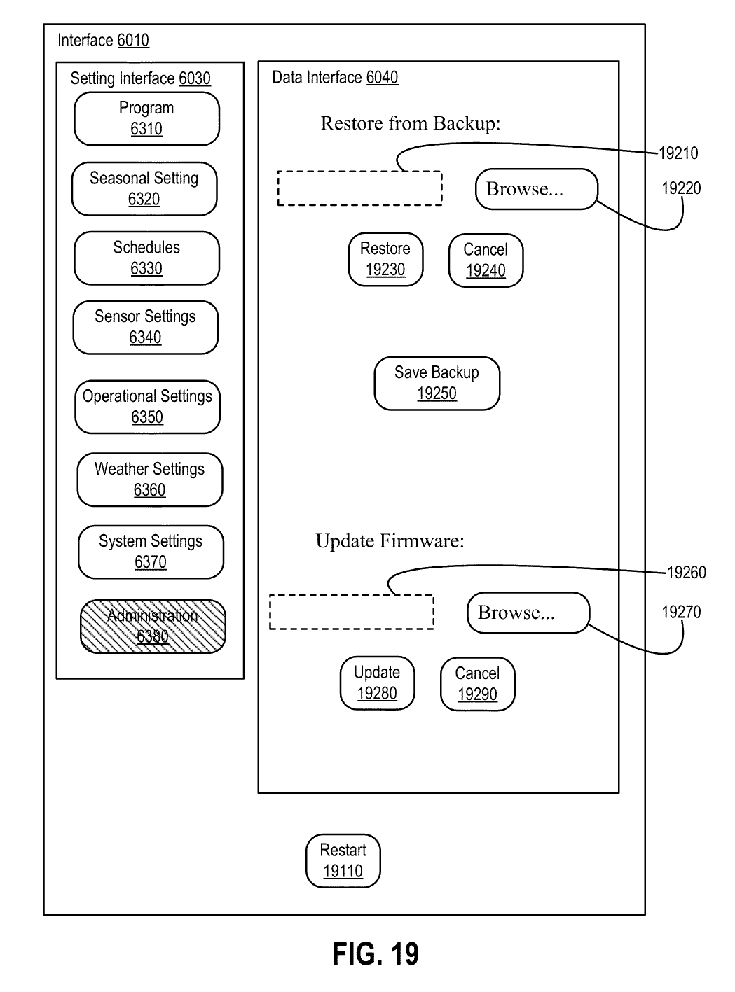

Turning now to FIGS. 20 and 21, an exemplary database schema is provided, according to one or more embodiments. As illustrated FIGS. 20 and 21, exemplary tables 20110-21150 are illustrated. In one or more embodiments, data utilized by device 3110 and/or system 1410 may be utilized in accordance with one or more of tables 20110-21150.

In one or more embodiments, data utilized in accordance with one or more of tables 20110-21150 may be stored via database data 5038 (illustrated in FIG. 5). For example, a database management system (DBMS) may utilize data in accordance with one or more of tables 20110-21150. For instance, the DBMS may include one or more of MySQL, SQLite, PostgreSQL, Oracle, dBASE, SQL Server, MS Access, Oracle, Sybase, DB2, and FoxPro, among others. In one or more embodiments, a DBMS may utilize one or more data structures to utilize data in accordance with one or more of tables 20110-21150. For example, utilizing the one or more data structures may include storing and/or retrieving, to and/or from a memory medium, data in accordance with the data structures.

In one or more embodiments, a DBMS may utilize one or more database triggers. For example, a database trigger may include a response to an event. For instance, the DBMS may initiate and/or execute one or more of a method and a process, among others, in response to one or more of a table modification and a table update, among others.

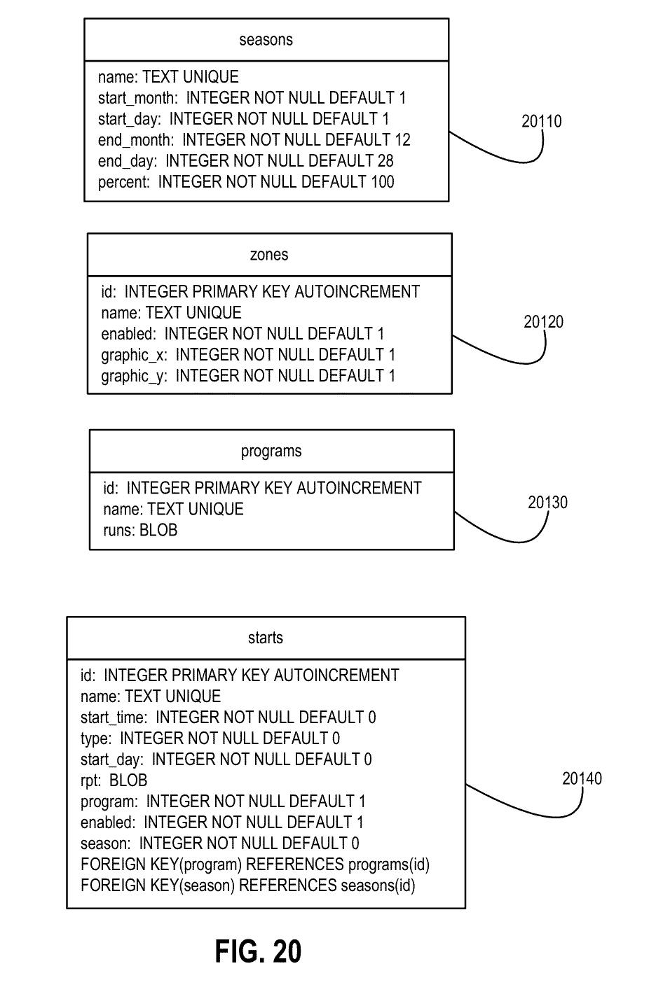

Turning now to FIG. 22, an exemplary diagram of computing devices coupled to a control system is illustrated, according to one or more embodiments. As shown, one or more of computing devices (CDs) 22110-22112 may be coupled to system 1410. In one or more embodiments, one or more of CDs 22110-22112 may be coupled to system 1410 in a wireless fashion. For example, system 1410 may host and/or control a local wireless network, such as an IEEE 802.11 network, a WiFi network, a wireless Ethernet network, a Bluetooth network, an IEEE 802.15 network, an IEEE 802.15.4 network, or a ZWave network, among others.

In one instance, system 1410 may provide WiFi access point capabilities, and one or more of CDs 22110-22112 may wireless communicate with system 1410 via a wireless network provided via the WiFi access point capabilities provided by system 1410. In a second instance, system 1410 may provide WiFi access point capabilities, and system 1410 may provide a SSID (e.g., “Bluespray”, “Sprinkler System”, etc.) to one or more of CDs 22110-22112 the WiFi access point capabilities provided by system 1410. In another instance, system 1410 may provide IEEE 802.15.4 access point capabilities and one or more of CDs 22110-22112 may wireless communicate with system 1410 via a wireless network provided via the IEEE 802.15.4 access point capabilities provided by system 1410.

In one or more embodiments, system 1410 may provide one or more Internet protocol (IP) addresses to respective one or more computing devices. For example, system 1410 may provide one or more IP addresses to respective one or more of CDs 22110-22112. For instance, system 1410 may provide one or more private and/or nonroutable IP addresses (e.g., IP address described in Request for Comments (RFC) 1918 available from the Internet Engineering Task Force (IETF)) to respective one or more of CDs 22110-22112.

In one or more embodiments, system 1410 may provide a domain name service (DNS) to one or more computing devices. In one example, system 1410 may provide a DNS to one or more of CDs 22110-22112. In another example, system 1410 may resolve one or more logical names (e.g., “myhouse.bluepary.com”, “sprinkler.bluespray.com”, “lawn.somedomain.com”, etc.) to at least one IP address that may be utilized by one or more of CDs 22110-22112. For instance, a DNS provided by system 1410 may resolve “sprinkler.bluespray.com” to an IP address of system 1410 (e.g., 192.168.100.1).

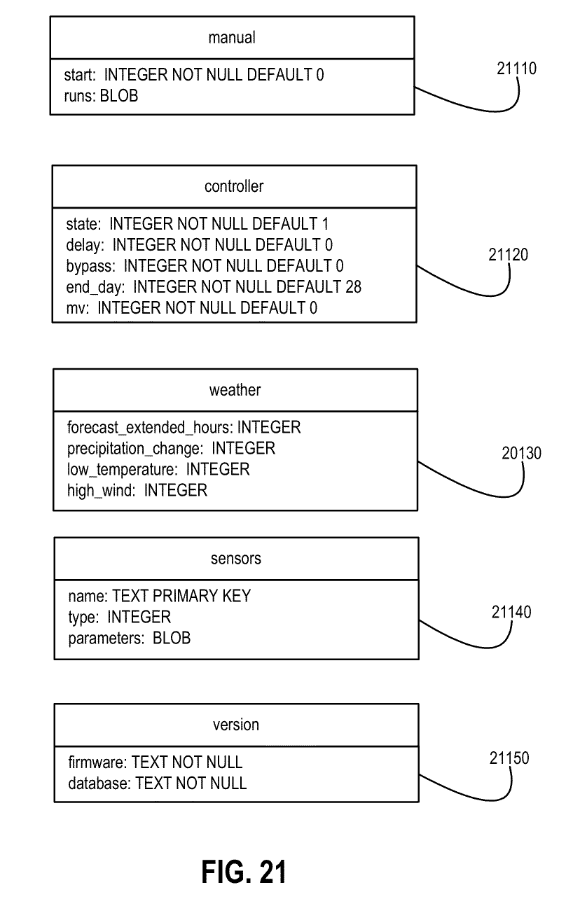

Turning now to FIG. 23, an exemplary diagram of computing devices coupled to a control system that is coupled to a network is illustrated, according to one or more embodiments. As shown, one or more of CDs 22110-22112 may be coupled to system 1410. In one or more embodiments, one or more of CDs 22110-22112 may be coupled to system 1410 in a wireless fashion. As illustrated, system 1410 may be coupled to a network 23010.

In one or more embodiments, network 23010 may include one or more of a wireless network and a wired network. In one or more embodiments, network 23010 may be coupled to one or more types of communications networks, such as one or more of a public wide area network (e.g., an Internet), a private wide area network, a local area network, a PSTN, a cellular telephone network, and a satellite telephone network, among others. In one example, network 23010 may form part of an Internet. In another example, network 23010 may be or include an Internet. In one or more embodiments, system 1410 may be coupled to network 23010 via a wired communication coupling and/or a wireless communication coupling. In one example, system 1410 may be coupled to network 23010 via wired Ethernet, a DSL (digital subscriber loop) modem, or a cable (television) modem, among others. In another example, system 1410 may be coupled to network 23010 via wireless Ethernet (e.g., WiFi), a satellite communication coupling, a cellular telephone coupling, or WiMax, among others.

In one or more embodiments, system 1410 may send information to a computer system via network 23010, and/or system 1410 may receive information from a computer system via network 23010. In one example, system 1410 may send information, via network 23010, to a computing device (CD) of a user. In one instance, system 1410 may send a message via one or more of email and a text message (e.g., a short message service (SMS) message), via network 23010, to a CD of a user to inform the user of a status change in system 1410. In another instance, system 1410 may send a message via one or more of email and a text message (e.g., a SMS message), via network 23010, to a CD of a user to inform the user of a postponement in a watering schedule.

In a second example, system 1410 may receive information, via network 23010, from a CD of a user. In another example, system 1410 may receive information, via network 23010, from a computer system coupled to network 23010. For instance, system 1410 may receive weather forecast information or watering restriction information, via network 23010, from a computer system coupled to network 23010. As one example, system 1410 may access a website of an appropriate municipality to retrieve watering restriction information based on a location of system 1410.

In general, most water restriction rules issued by municipalities are similar. That is, water restriction rules basically ration watering days by address. There are some exceptions, but water-by-address is by far the most popular. Municipalities typically post their water restriction rules on their website to inform customers of when the customers can water. One problem is that not all customers are aware of the water restrictions and the customers who are of the water restrictions may not be sure of what the water restrictions mean and/or when the water restrictions change. In general, the water restriction instructions are clear for humans to read, but in order for machine to understand the water restrictions the water restrictions need to be translated into computer data (in order for the computer to consume the water restrictions).

According to one embodiment, water restriction rules are translated into a computer data format, e.g., JavaScript Object Notation (JSON), which is a data-interchangeable format. In general, JSON is relatively easy for humans to read and for machines to consume and there are many programs available that understand JSON. The JSON data format consists of a key and value format, where the key tells you what the field means and the value tells you what is in the field. For example, a typical water restriction rule may be described in JSON using a field format as follows: stages, a list of water restriction stages, e.g., stage 1, stage 2, stage 3, etc.; current, a current stage number; effective, an effective date that the current stage takes effect; types, a list of optional entity types, e.g., business, residential, school, etc.; and rules, a list of rules for each stage.

Each stage in the rules specifies the day or days per week to water, the time to water, the interval to repeat (e.g., per week, 3 days, etc.), and the list of numbers represents the last number of an address. A typical rule for a stage may be given as follow: time, a list of time windows in which watering is allowed with a start time and end time, e.g., start at 0000 and end at 0959; day, a list of days of the week that watering is allowed; interval, a repeat interval in days; and an address, a list of numbers that represents the last digit of the home address. For example, a JSON representation for implementing water restrictions may take the following form:

```
/*
* Exemplary Water Restriction data (JSON) representation
*
* Keys:
* stages: list of water restriction name
* types: list of consumer type.
* current: index number of current WR stage i.e. 0 = “Stage 1”, 1 = “Stage 2” ...
* effective: the date the WR goes into effect for reference purposes (yyyy-mm-dd)
* rules: the actual rules of the WR, which contains a list of rules for each
* consumer type. Example, rules[1][0] would refer to ‘Stage 2 -> residential’ rules
* interval: frequency in days to repeat i.e. 7 = weekly, 14 = every 2 week, etc.
* days: list of the day(s) that watering is time. 0 = Sunday
* addresses: list of the addresses that end in these numbers (odds or evens)
* time: list of the time slots that watering is allowed in integer. 0 = 12 AM, 2359 = 11:59
PM
*/
{
  stages: [ “Stage 1”, “Stage 2”, “Stage 3” ],
  types: [ “resident”, “commercial”, “schools” ],
  current : 1,
  effective : “2013-07-08”,
  rules : [
    { // Stage 1
      [
        {
          interval : 7, // every week
          days : [2,6], // Tuesday and Friday
          addresses : [0,1,2,3,4,5,6,7,8,9], // all addresses
          time : [
            {
              from : 0,
              to : 500
            },
            {
              from : 1900,
              to : 2359
            }
          ]
        }
      ]
    },
    { // Stage 2
      [ // residential
        {
          interval : 7,
          days : [3], // Wednesday only
          addresses : [1,3,5,7,9], // odd addresses
          time : [
            {
              from : 0,
              to : 500
            },
            {
              from : 1900,
              to : 2359
            }
          ]
        },
        {
          interval : 7,
          days : [4],
          addresses : [0,2,4,6,8], // even addresses
          time : [
            {
              from : 0,
              to : 500
            },
            {
              from : 1900,
              to : 2359
            }
          ]
        }
      ],
      [ // commercial
        {
          interval : 7,
          days : [5],
          addresses : [1,3,5,7,9],
          time : [
            {
              from : 0,
              to : 500
            },
            {
              from : 1900,
              to : 2359
            }
          ]
        },
        {
          days : [2],
          addresses : [0,2,4,6,8],
          time : [
            {
              from : 0,
              to : 500
            },
            {
              from : 1900,
              to : 2359
            }
          ]
        }
      ],
      [ // schools
        {
          interval : 7,
          days : [1],
          addresses : [0,1,2,3,4,5,6,7,8,9], // All addresses
          time : [
            {
              from : 0,
              to : 500
            },
            {
              from : 1900,
              to : 2359
            }
          ]
        }
      ]
    },
    { // Stage 3
      [
        {
          interval : 14,
          days : [3],
          addresses : [0,1,2,3,4,5,6,7,8,9],
          time : [
            {
              from : 0700,
              to : 1100
            },
            {
              from : 1900,
              to : 2359
            }
          ]
        }
      ]
    }
  ]
}
```

In general, each water authority would translate their water restriction rules into the above data format and make the water restriction rules available on their website. For example, a water restriction tool may be made available on a website for the water authority to build their rules and for translating the rules into a computer data format.

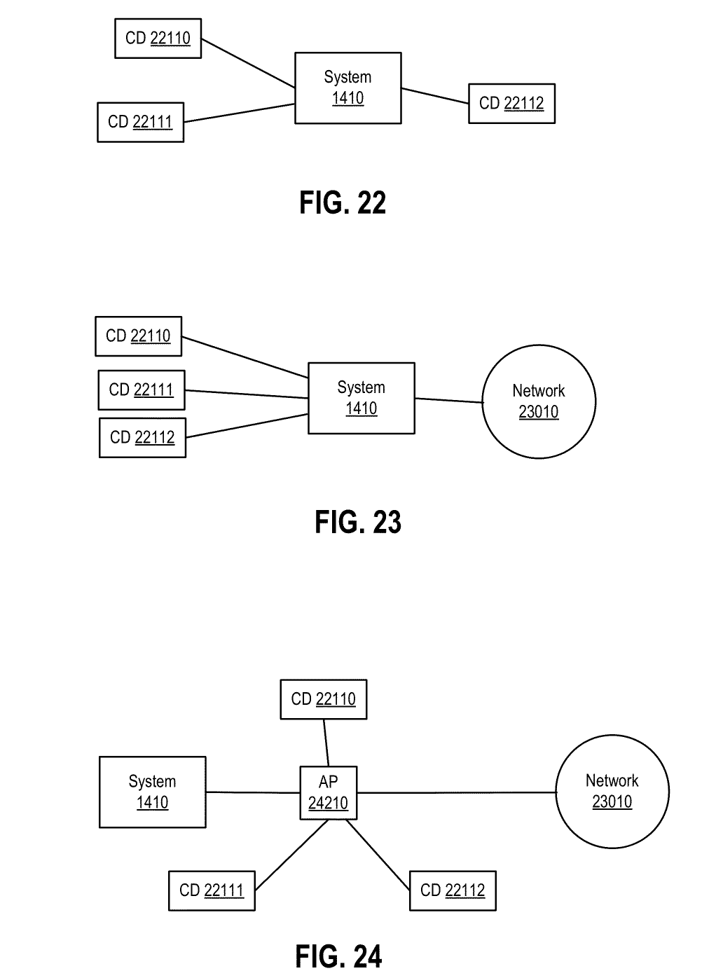

Turning now to FIG. 24, an exemplary diagram of computing devices and a control system coupled to an access point that is coupled to a network is illustrated, according to one or more embodiments. As shown, one or more of CDs 22110-22112 may be coupled to AP 24210. In one or more embodiments, one or more of CDs 22110-22112 and system 1410 may be coupled to AP 24210 in a wireless fashion, and/or one or more of CDs 22110-22112 and system 1410 may be coupled to AP 24210 in a wired fashion. As illustrated, AP 24210 may be coupled to network 23010. In one example, AP 24210 may be coupled to network 23010 via wired Ethernet, a DSL (digital subscriber loop) modem, or a cable (television) modem, among others. In another example, AP 24210 may be coupled to network 23010 via wireless Ethernet (e.g., WiFi), a satellite communication coupling, a cellular telephone coupling, or WiMax, among others.

In one or more embodiments, system 1410 may be coupled to AP 24210 via one or more of a WiFi coupling, an IEEE 802.11 coupling, and a wireless Ethernet coupling, among others. For example, system 1410 may function in accordance with an infrastructure mode with AP 24210 as its wireless AP.

In one or more embodiments, one or more structures and/or functionalities of system 1410 described with reference to FIGS. 22-24 may be implemented with one or more structures and/or functionalities of device 3110. In one example, system 1410 may implement one or more wireless AP structures and/or functionalities via one or more of processing unit 5010, memory medium 5020, memory medium 5025, and local wireless interface 5050 of device 3110. In a second example, system 1410 may be coupled to network 23010 via network interface 5040 of device 3110. In a third example, system 1410 may provide one or more IP addresses via processing unit 5010 and at least one of memory media 5020 and 5025 of device 3110. In another example, system 1410 may provide a domain name service via processing unit 5010 and at least one of memory media 5020 and 5025 of device 3110.

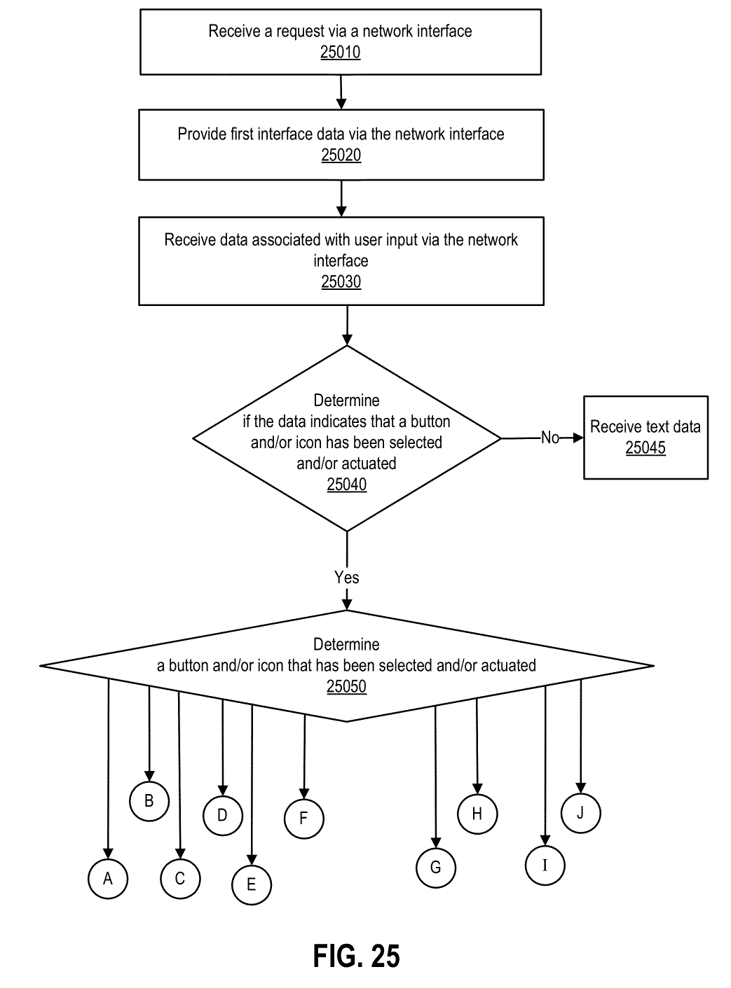

Turning now to FIGS. 25 and 26, a method of providing and operating an interface of a system is illustrated, according to one or more embodiments. In one or more embodiments, the method provided via FIGS. 25 and 26 may be utilized in providing and operating an interface of system 1410. At 25010, a request may be received via a network interface. In one example system, 1410 may receive the request via network interface 5040 of device 3110. In another example, system 1410 may receive the request via local wireless interface 5050 of device 3110.

In one or more embodiments, the request may be a request for data. In one example, the request may include a hypertext transfer protocol (HTTP) “GET” request. In another example, the request may include a hypertext transfer protocol secure (HTTPS) “GET” request. In one or more embodiments, system 1410 may include a web server. For example, one or more of APPs 5031-5033 may include a web server, and processing unit 5010 may execute the one or more of APPs 5031-5033 that includes the web server to implement the web server of system 1410.

At 25020, first interface data may be provided via the network interface. In one example, system 1410 may provide the first interface data via network interface 5040 of device 3110. In another example, system 1410 may provide the first interface data via local wireless interface 5050 of device 3110. In one or more embodiments, the first interface data may include one or more of hypertext markup language (HTML) data, a script (e.g., a JavaScript script), and graphic data, among others. For example, the first interface data may include a web page that is displayable via a web browser of a computing device. For instance, the web page may include interface functionality as described with reference to FIG. 6.

At 25030, data associated with user input may be received via the network interface. In one example system, 1410 may receive the data associated with user input via network interface 5040 of device 3110. In another example, system 1410 may receive the data associated with user input via local wireless interface 5050 of device 3110. At 25040, it may be determined if the data associated with user input indicates that a button and/or icon has been selected and/or actuated. If the data associated with user input does not indicate that the button and/or icon has been selected and/or actuated, text data may be received at 25045. If the data associated with user input indicates that a button and/or icon of buttons or icons 6110, 6120, and 6310-6380 has been actuated and/or selected, it can be determined which buttons or icons 6110, 6120, and 6310-6380 has been actuated or selected at 25050.

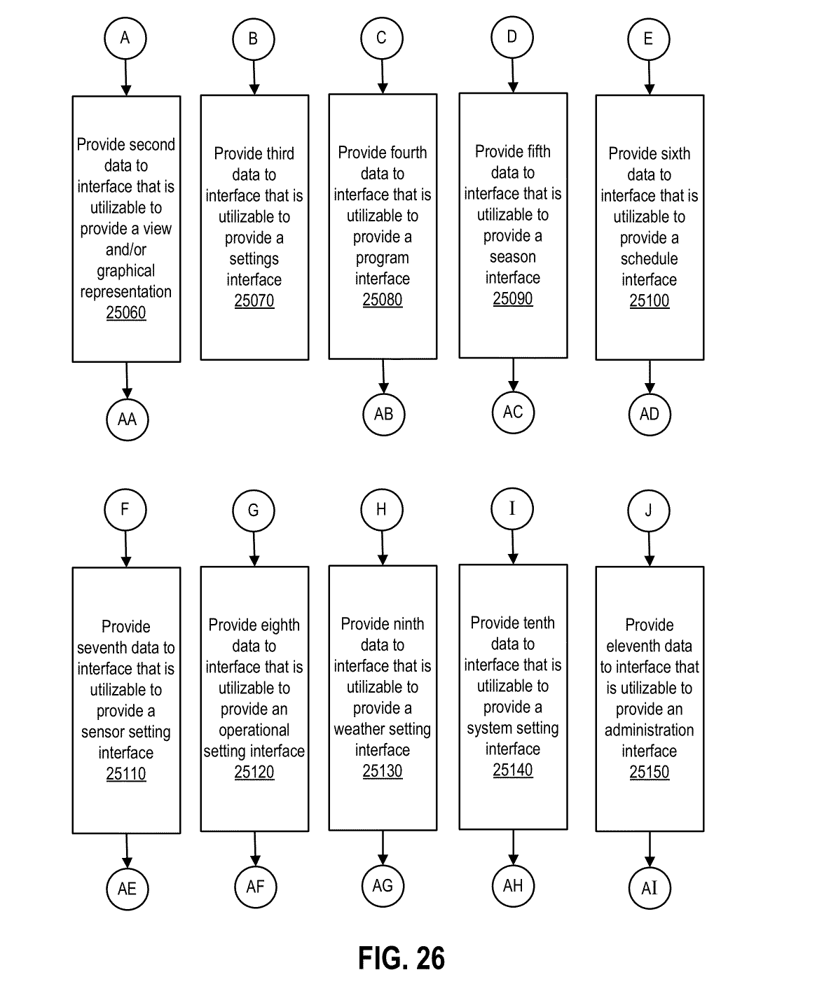

If button and/or icon 6110 has been selected and/or actuated, second data may be provided, via the network interface, to interface 6010 that is utilizable to provide a view and/or graphical representation of land and/or one or more buttons and/or icons, at 25060 (illustrated in FIG. 26). For example, the second data may be provided to interface 6010 may be utilizable to provide a view and/or graphical representation of land 7010 and/or one or more buttons and/or icons 7410 and 7420, as illustrated in FIG. 7. In one or more embodiments, the method may proceed to 27110 (illustrated in FIG. 27). If button and/or icon 6120 has been selected and/or actuated, third data may be provided, via the network interface, to interface 6010 that is utilizable to provide a settings interface, at 25070 (illustrated in FIG. 26).

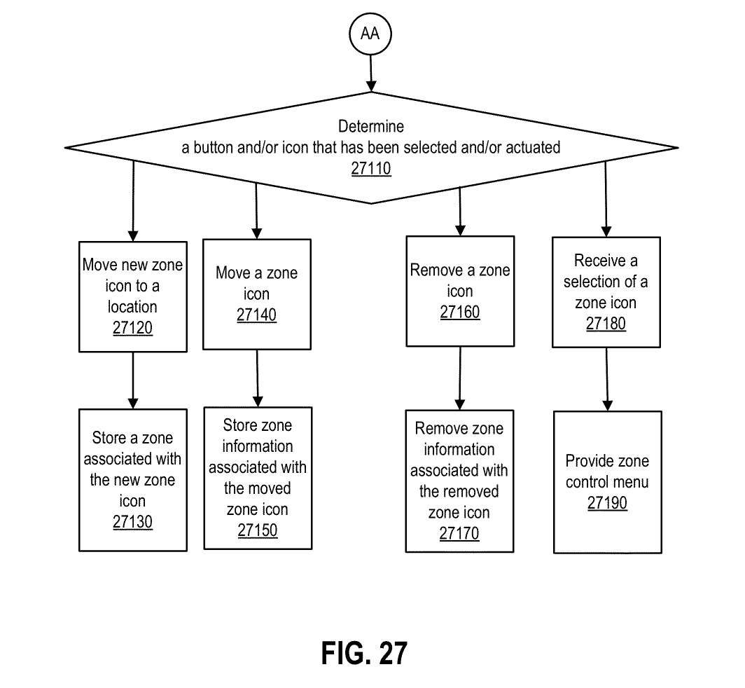

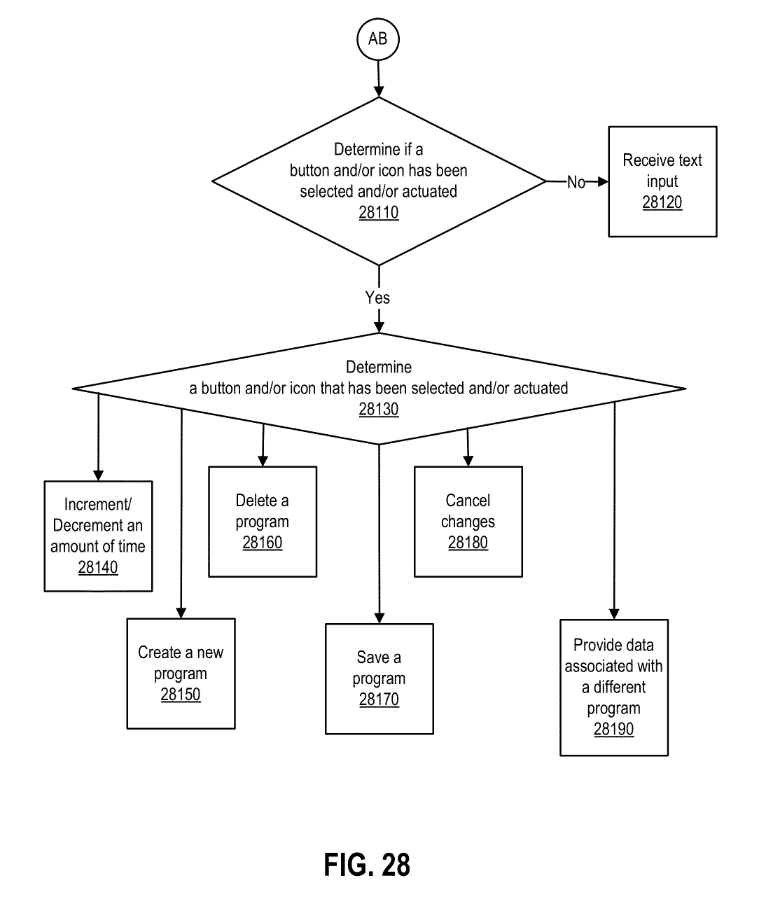

If button and/or icon 6310 has been selected and/or actuated, fourth data may be provided, via the network interface, to interface 6010 that is utilizable to provide a program interface, at 25080 (illustrated in FIG. 26). For example, the fourth data may be provided to interface 6010 may be utilizable to provide a program interface, as illustrated in FIG. 11. In one or more embodiments, the method may proceed to 28110 (illustrated in FIG. 28). If button and/or icon 6320 has been selected and/or actuated, fifth data may be provided, via the network interface, to interface 6010 that is utilizable to provide a seasonal setting interface, at 25090 (illustrated in FIG. 26). For example, the fifth data may be provided to interface 6010 may be utilizable to provide a seasonal setting interface, as illustrated in FIG. 12. In one or more embodiments, the method may proceed to 29110 (illustrated in FIG. 29).

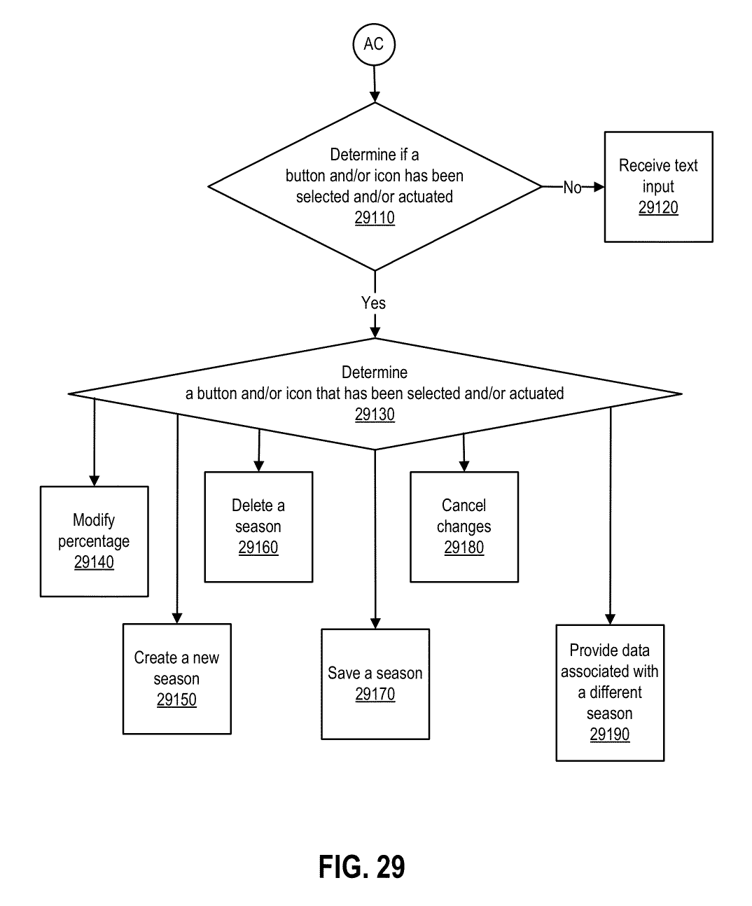

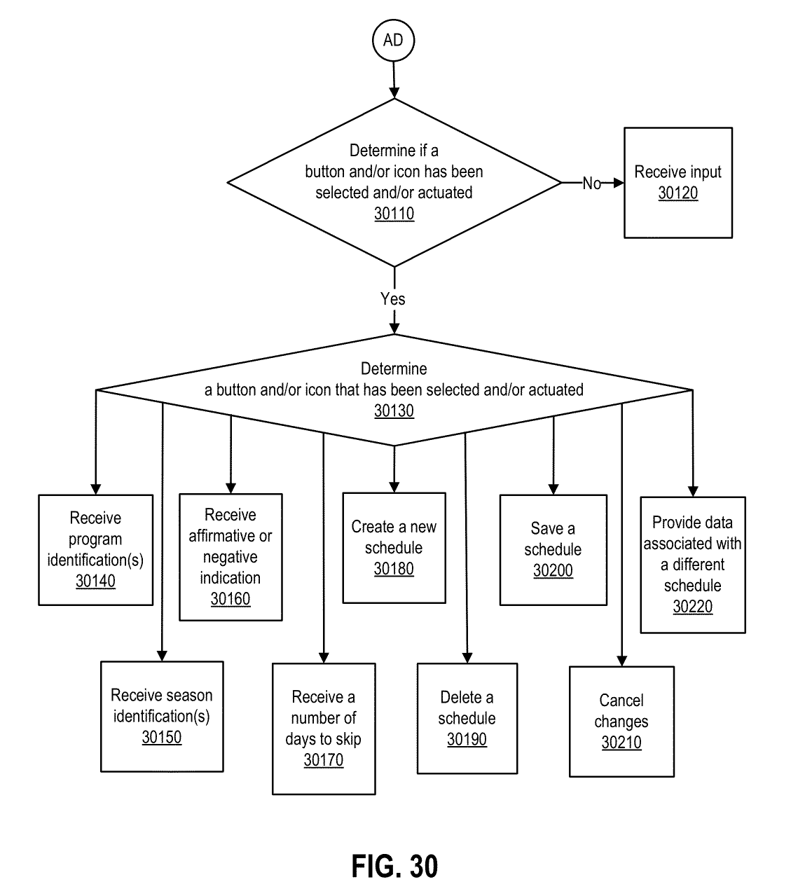

If button and/or icon 6330 has been selected and/or actuated, sixth data may be provided, via the network interface, to interface 6010 that is utilizable to provide a schedules interface, at 25100 (illustrated in FIG. 26). For example, the sixth data may be provided to interface 6010 may be utilizable to provide a schedules interface, as illustrated in FIG. 13. In one or more embodiments, the method may proceed to 30110 (illustrated in FIG. 30). If button and/or icon 6340 has been selected and/or actuated, seventh data may be provided, via the network interface, to interface 6010 that is utilizable to provide a sensor setting interface, at 25110 (illustrated in FIG. 26). For example, the seventh data may be provided to interface 6010 may be utilizable to provide a sensor setting interface, as illustrated in FIG. 14. In one or more embodiments, the method may proceed to 31110 (illustrated in FIG. 31).

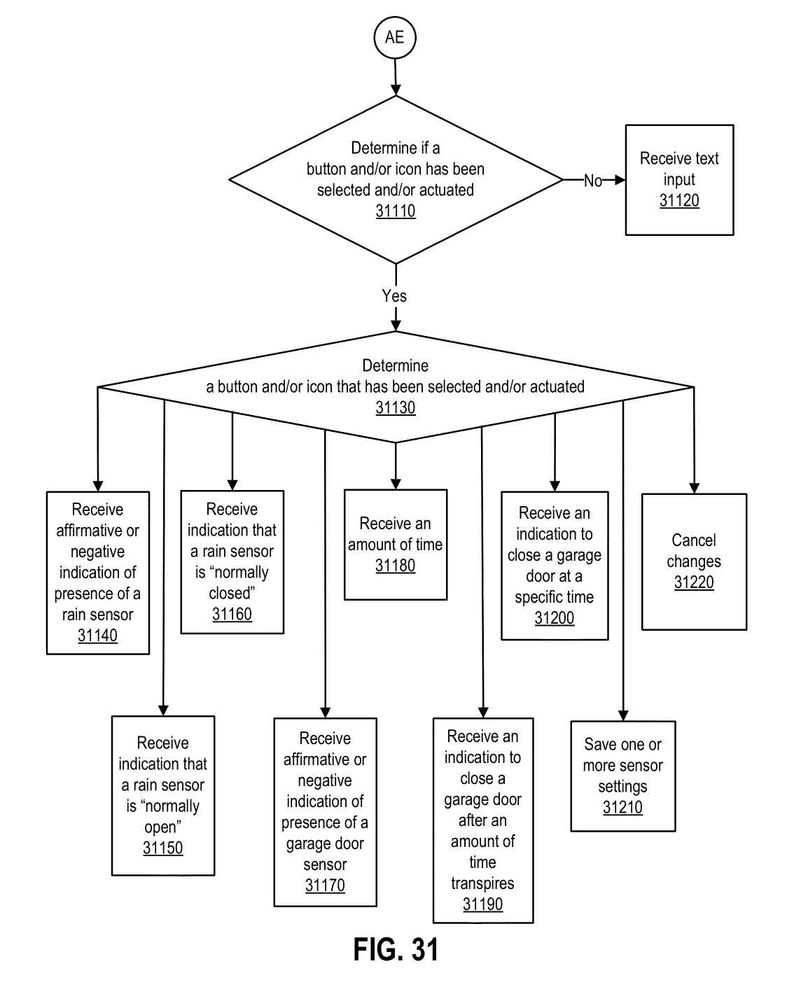

If button and/or icon 6350 has been selected and/or actuated, eighth data may be provided, via the network interface, to interface 6010 that is utilizable to provide an operational setting interface, at 25120 (illustrated in FIG. 26). For example, the eighth data may be provided to interface 6010 may be utilizable to provide an operational setting interface, as illustrated in FIG. 15. In one or more embodiments, the method may proceed to 32110 (illustrated in FIG. 32).

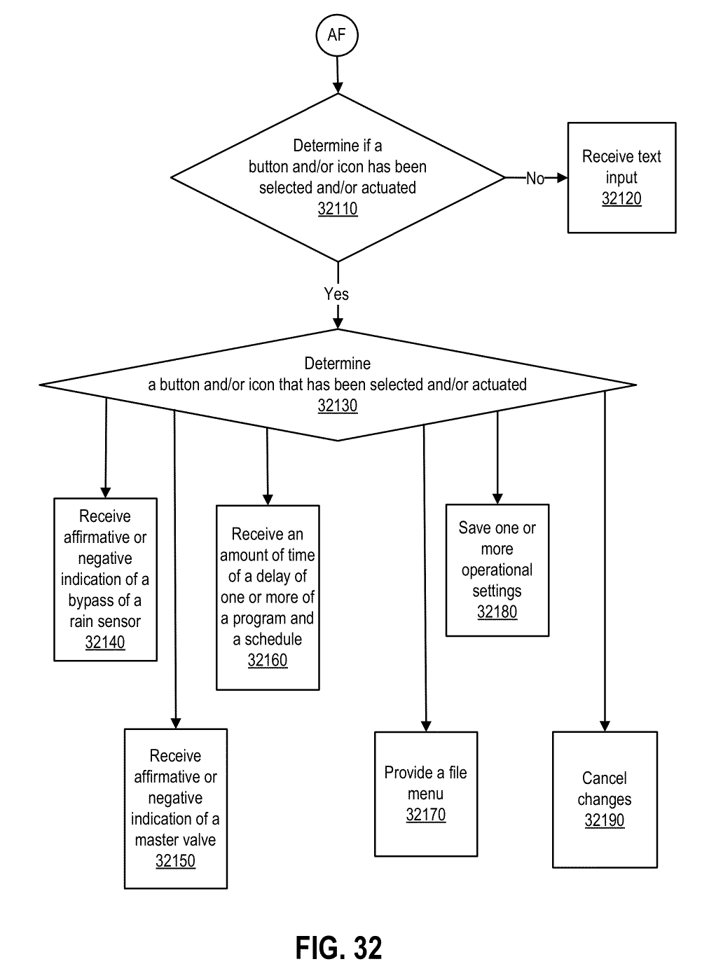

If button and/or icon 6360 has been selected and/or actuated, ninth data may be provided, via the network interface, to interface 6010 that is utilizable to provide a weather setting interface, at 25130 (illustrated in FIG. 26). For example, the ninth data may be provided to interface 6010 may be utilizable to provide a weather setting interface, as illustrated in FIG. 16. In one or more embodiments, the method may proceed to 33110 (illustrated in FIG. 33).

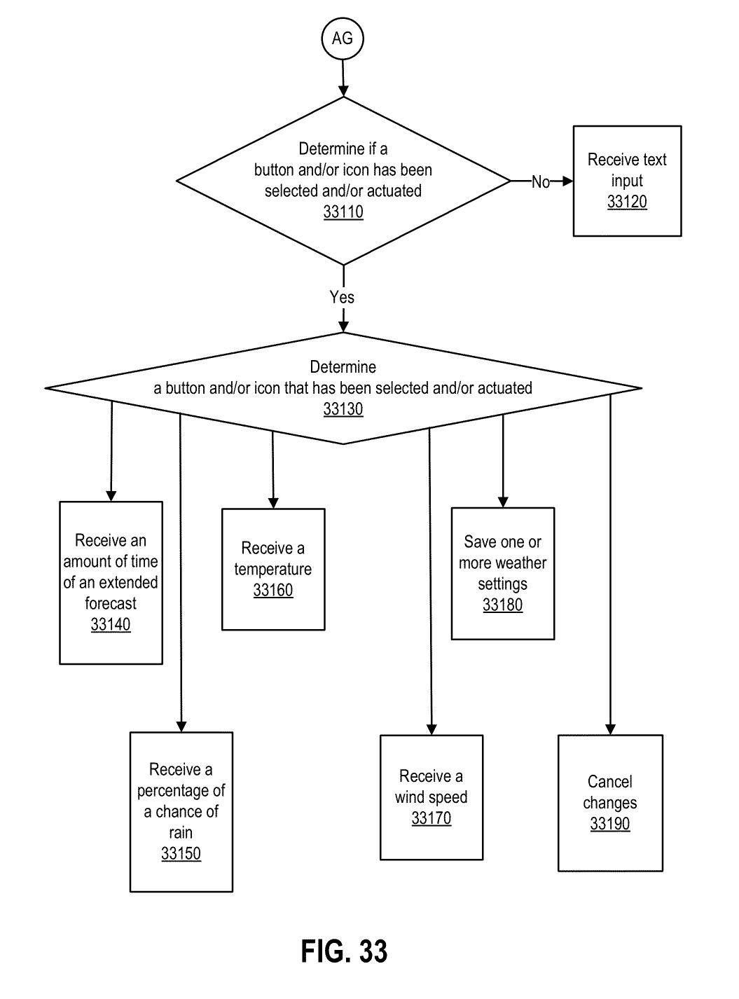

If button and/or icon 6370 has been selected and/or actuated, tenth data may be provided, via the network interface, to interface 6010 that is utilizable to provide a system setting interface, at 25140 (illustrated in FIG. 26). For example, the tenth data may be provided to interface 6010 may be utilizable to provide a system setting interface, as illustrated in FIG. 17. In one or more embodiments, the method may proceed to 34110 (illustrated in FIG. 34).

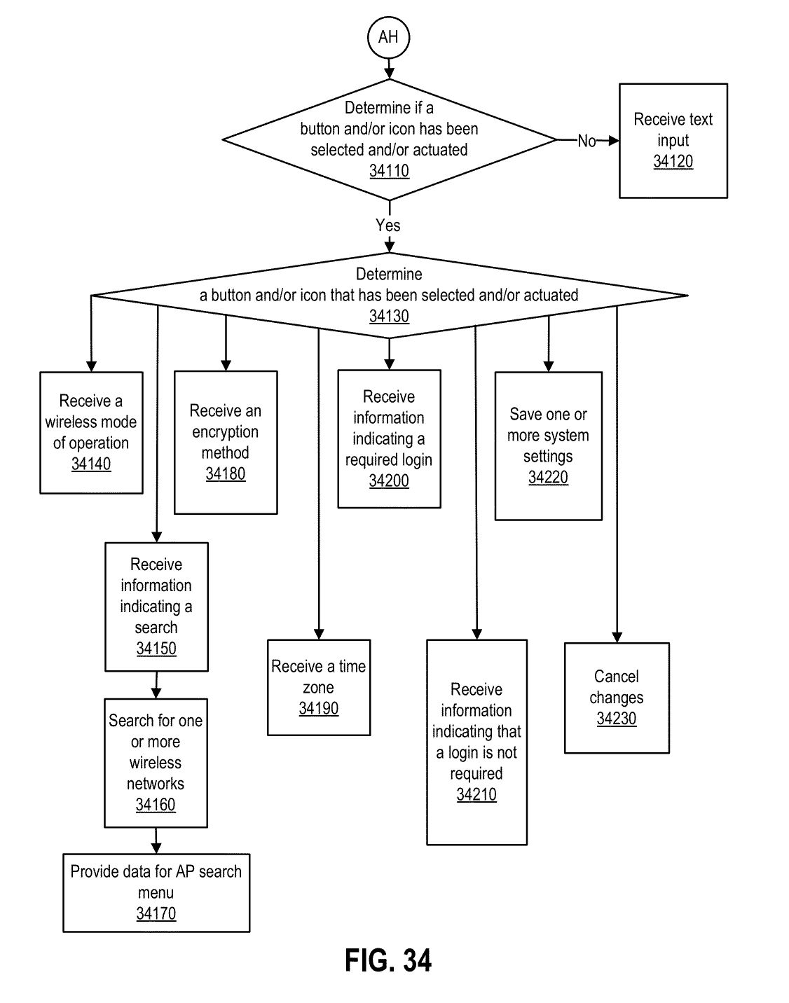

If button and/or icon 6380 has been selected and/or actuated, eleventh data may be provided, via the network interface, to interface 6010 that is utilizable to provide an administration setting interface, at 25150 (illustrated in FIG. 26). For example, the eleventh data may be provided to interface 6010 may be utilizable to provide an administration interface, as illustrated in FIG. 19. In one or more embodiments, the method may proceed to 35110 (illustrated in FIG. 35).

Turning now to FIG. 27, an exemplary method of placing and/or removing zones of a fluid distribution system is illustrated, according to one or more embodiments. At 27110, a button and/or icon that has been selected and/or actuated may be determined. In one or more embodiments, a button and/or icon of buttons and/or icons 7410, 8110-8150, and 8170 may be determined as having been selected and/or actuated. For example, button and/or icon 7410 may be determined as having been selected and/or actuated.

At 27120, a new zone icon may be moved to a location. As illustrated in FIG. 8, for example, zone icon and/or button 7410 may be selected and/or utilized by a user to obtain a new fluid distribution zone. For instance, the user may drag and drop zone icon and/or button 7410 to a location included in data interface 6040. At 27130, a zone associated with zone icon 8160 may stored in a memory medium. For example, the zone associated with zone icon 8160 may stored in zones table 20120 (illustrated in FIG. 20). For instance, storing the zone associated with zone icon 8160 may include inserting zone information, associated with the zone associated with zone icon 8160, into zones table 20120 (illustrated in FIG. 20).

At 27140, a zone icon may be moved to a new and/or different location. For example, a zone icon of zone icons 8110-8150, and 8170 (as illustrated in FIG. 8) may be moved to a new and/or different location. For instance, a user may drag and drop a zone icon of zone icons 8110-8150, and 8170 to a location included in data interface 6040. At 27140, zone information, associated with the moved zone icon, may be stored in a memory medium. For example, the zone information associated with the moved zone icon may stored in zones table 20120 (illustrated in FIG. 20). For instance, storing the zone information associated with the moved zone icon may include updating the zone information of an entry (e.g., a row) of table 20120 (illustrated in FIG. 20).

At 27160, a zone icon may be removed. For example, a zone icon of zone icons 8110-8170 (as illustrated in FIG. 9) may be removed. For instance, a user may drag and drop zone icon 8150 to icon 7420 of data interface 6040, as illustrated in FIG. 9. At 27170, zone information, associated with the moved zone icon, may be removed from a memory medium. For example, the zone information associated with the removed zone icon may removed from zones table 20120 (illustrated in FIG. 20). For instance, removing the zone information associated with the removed zone icon may include deleting the zone information of an entry (e.g., a row) of table 20120 (illustrated in FIG. 20). In one or more embodiments, removing information from a memory medium may include making one or more portions of the memory medium that store the information available for overwriting and/or available for storing other information.

At 27180, a zone icon selection may be received. For example, a selection of a zone icon of zone icons 8110-8170 (as illustrated in FIG. 8), selected by a user, may be received. At 27190, a zone control menu (e.g., zone control menu 10010 of FIG. 10) may be provided. For example, the user may double click zone icon 8130 (as illustrated in FIG. 8), and zone control menu 10010 (as illustrated in FIG. 10) may be provided in response to the user double clicking zone icon 8130.

Turning now to FIG. 28, an exemplary method of operating a program interface of a fluid distribution system is illustrated, according to one or more embodiments. At 28110, it may be determined if a button and/or icon has been selected and/or actuated. If a button and/or icon has been selected and/or actuated, the method may proceed to 28130. If a button and/or icon has not been selected and/or actuated, text input may be received at 28120. For example, a program name may be received via input area 11205 (as illustrated in FIG. 11).

At 28130, a button and/or icon that has been selected and/or actuated may be determined. If an increment/decrement element of increment/decrement elements 11210-11280 (as illustrated in FIG. 11) is selected, an amount of time may be incremented and/or decremented to and/or from an amount of time that system 1410 may permit fluid to flow, at 28140. In one example, the user may select and/or actuate a top portion of increment/decrement element 11210 to add a minute to an amount of time that system 1410 permits water to flow a zone in a water sprinkler system associated with the name “Zone 1”. In another example, the user may select and/or actuate a bottom portion of increment/decrement element 11220 to subtract a minute to an amount of time that system 1410 permits water to flow a zone in a water sprinkler system associated with the name “Zone 2”.

If button and/or icon 11110 (illustrated in FIG. 11) is selected and/or actuated, a new program may be created at 28150. If button and/or icon 11120 (illustrated in FIG. 11) is selected and/or actuated, a program may be deleted at 28160. For example, a program associated with a name of “July Program” may be removed from a memory medium and/or removed from programs table 20130 (illustrated in FIG. 20). For instance, removing the program associated with the name of “July Program” may include deleting the program information of an entry (e.g., a row) of table 20130 (illustrated in FIG. 20). In one or more embodiments, removing information from a memory medium may include making one or more portions of the memory medium that store the information available for overwriting and/or available for storing other information.

If button and/or icon 11130 (illustrated in FIG. 11) is selected and/or actuated, a program may be saved at 28170. For example, a program associated with a name of “July Program” may be stored in a memory medium, added to programs table 20130 (illustrated in FIG. 20), and/or information associated with the program may be utilized to update programs table 20130. In one instance, storing the program associated with the name of “July Program” may include inserting the program information into a new entry (e.g., a new row) of table 20130 (illustrated in FIG. 20). In another instance, storing the program associated with the name of “July Program” may include updating the program information of an entry (e.g., a row) of table 20130.

If button and/or icon 11140 (illustrated in FIG. 11) is selected and/or actuated, any changes to a program may be discarded at 28180. For example, any changes associated with a program associated with a name of “July Program” may be discarded. If button and/or icon 11150 or button and/or icon 11160 (illustrated in FIG. 11) is selected and/or actuated, data associated with a different program may be provided at 28190. For example, the data associated with the different program may be utilizable to display a different program.

Turning now to FIG. 29, an exemplary method of operating a seasonal setting interface of a fluid distribution system is illustrated, according to one or more embodiments. At 29110, it may be determined if a button and/or icon has been selected and/or actuated. If a button and/or icon has been selected and/or actuated, the method may proceed to 29130.

If a button and/or icon has not been selected and/or actuated, text input may be received at 29120. In one example, a season name may be received via input area 12210 (as illustrated in FIG. 12). In a second example, a “from date” may be received via input area 12220 (as illustrated in FIG. 12). In a third example, a “to date” may be received via input area 12230 (as illustrated in FIG. 12). In another example, a percentage (e.g., a number) may be received via input area 12240 (as illustrated in FIG. 12).

At 29130, a button and/or icon that has been selected and/or actuated may be determined. If slider 12250 (as illustrated in FIG. 12) is selected and/or actuated, a percentage may be modified at 29140. In one example, a user may slide slider 12250 to the left to lower a percentage. For instance, input area 12240 may display the lowered percentage. In another example, the user may slide slider 12250 to the right to increase a percentage. For instance, input area 12240 may display the increased percentage.

If button and/or icon 12110 (illustrated in FIG. 12) is selected and/or actuated, a new season may be created at 29150. If button and/or icon 12120 (illustrated in FIG. 12) is selected and/or actuated, a season may be deleted at 29160. For example, a season associated with a name of “Spring” may be removed from a memory medium and/or removed from seasons table 20110 (illustrated in FIG. 20). For instance, removing the season associated with the name of “Spring” may include deleting the season information of an entry (e.g., a row) of table 20110 (illustrated in FIG. 20). In one or more embodiments, removing information from a memory medium may include making one or more portions of the memory medium that store the information available for overwriting and/or available for storing other information.

If button and/or icon 12130 (illustrated in FIG. 12) is selected and/or actuated, a season may be saved at 29170. For example, a season associated with a name of “Spring” may be stored in a memory medium, added to seasons table 20110 (illustrated in FIG. 20), and/or information associated with the season may be utilized to update seasons table 20110. In one instance, storing the season associated with the name of “Spring” may include inserting the season information into a new entry (e.g., a new row) of table 20110 (illustrated in FIG. 20). In another instance, storing the season associated with the name of “Spring” may include updating the season information of an entry (e.g., a row) of table 20110.

If button and/or icon 12140 (illustrated in FIG. 12) is selected and/or actuated, any changes to a season may be discarded at 29180. For example, any changes associated with a season associated with a name of “Spring” may be discarded. If button and/or icon 12150 or button and/or icon 12160 (illustrated in FIG. 12) is selected and/or actuated, a data associated with a different season may be provided at 29190. For example, the data associated with the different season may be utilized to display a different season.

Turning now to FIG. 30, an exemplary method of operating a schedules interface of a fluid distribution system is illustrated, according to one or more embodiments. At 30110, it may be determined if a button and/or icon has been selected and/or actuated. If a button and/or icon has been selected and/or actuated, the method may proceed to 30130.

If a button and/or icon has not been selected and/or actuated, input may be received at 30120. In one example, a schedule name may be received via input area 13210 (as illustrated in FIG. 13). In a second example, a “start time” may be received via input area 13220 (as illustrated in FIG. 13). In another example, an indication of one or more of “even days”, “odd days”, “every day”, “week days”, “weekends”, “Monday”, “Tuesday”, “Wednesday”, “Thursday”, “Friday”, “Saturday”, and “Sunday” may be received via corresponding checkboxes (as illustrated in FIG. 13).

At 30130, a button and/or icon that has been selected and/or actuated may be determined. If dropdown menu 13230 (as illustrated in FIG. 13) is selected and/or actuated, a program identification from a list of program identification(s) may be received at 30140. In one or more embodiments, a schedule may be included in a one-to-one relationship with a program.

If dropdown menu 13240 (as illustrated in FIG. 13) is selected and/or actuated, a season identification from a list of season identification(s) may be received at 30150. If dropdown menu 13250 (as illustrated in FIG. 13) is selected and/or actuated, an affirmative indication or a negative indication of an active status of a schedule may be received at 30160. If dropdown menu 13260 (as illustrated in FIG. 13) is selected and/or actuated, a number of days to skip between fluid distributions may be received at 30170. For example, the number of days to skip between fluid distributions that may be received may include a number of days to skip between water distribution is a water sprinkler system.

If button and/or icon 13110 (illustrated in FIG. 13) is selected and/or actuated, a new schedule may be created at 30180. If button and/or icon 13120 (illustrated in FIG. 13) is selected and/or actuated, a schedule may be deleted at 30190. For example, a schedule associated with a name of “Morning” may be removed from a memory medium and/or removed from starts table 20140 (illustrated in FIG. 20). For instance, removing the schedule associated with the name of “Morning” may include deleting the schedule information of an entry (e.g., a row) of table 20140 (illustrated in FIG. 20). In one or more embodiments, removing information from a memory medium may include making one or more portions of the memory medium that store the information available for overwriting and/or available for storing other information.

If button and/or icon 13130 (illustrated in FIG. 13) is selected and/or actuated, a schedule may be saved at 30200. For example, a schedule associated with a name of “Morning” may be stored in a memory medium, added to starts table 20140 (illustrated in FIG. 20), and/or information associated with the schedule may be utilized to update starts table 20140. In one instance, storing the season associated with the name of “Morning” may include inserting the schedule information into a new entry (e.g., a new row) of table 20140 (illustrated in FIG. 20). In another instance, storing the schedule associated with the name of “Morning” may include updating the schedule information of an entry (e.g., a row) of table 20140.

If button and/or icon 13140 (illustrated in FIG. 13) is selected and/or actuated, any changes to a season may be discarded at 30210. For example, any changes associated with a schedule associated with a name of “Morning” may be discarded. If button and/or icon 13150 or button and/or icon 13160 (illustrated in FIG. 13) is selected and/or actuated, a data associated with a different schedule may be provided at 30220. For example, the data associated with the different schedule may be utilizable to display a different schedule.

Turning now to FIG. 31, an exemplary method of operating a sensor settings interface is illustrated, according to one or more embodiments. At 31110, it may be determined if a button and/or icon has been selected and/or actuated. If a button and/or icon has been selected and/or actuated, the method may proceed to 31130. If a button and/or icon has not been selected and/or actuated, text input may be received at 31120. For example, a time may be received via input area 14270 (as illustrated in FIG. 14).

At 31130, a button and/or icon that has been selected and/or actuated may be determined. If dropdown menu 14210 (as illustrated in FIG. 14) is selected and/or actuated, an affirmative or a negative indication may be received, at 31140, where the affirmative or the negative indication may indicate if a rain sensor is present or coupled to system 1410. If checkbox 14220 (as illustrated in FIG. 14) is checked, an indication that a function of a rain sensor is “normally open” may be received at 31150. If checkbox 14230 (as illustrated in FIG. 14) is checked, an indication that a function of a rain sensor is “normally closed” may be received at 31160.

If dropdown menu 14240 (as illustrated in FIG. 14) is selected and/or actuated, an affirmative or a negative indication may be received, at 31170, where the affirmative or the negative indication may indicate if a garage door sensor is present or coupled to system 1410. If dropdown menu 14250 (as illustrated in FIG. 14) is selected and/or actuated, an amount of time may be received, at 31180, where the amount of time indicates an amount of time that may transpire while a garage door is in an open position. If checkbox 14250 (as illustrated in FIG. 14) is checked, an indication that a garage door may be closed after the amount of time transpires may be received at 31190. If checkbox 14280 (as illustrated in FIG. 14) is checked, an indication that a garage door may be closed at a specific time may be received at 31200.

If button and/or icon 14110 (illustrated in FIG. 14) is selected and/or actuated, one or more sensor settings may be saved at 31210. For example, one or more sensor setting may be stored in a memory medium, added to sensors table 21140 (illustrated in FIG. 21), and/or information associated with the one or more sensor settings may be utilized to update sensors table 21140. In one instance, storing the one or more sensor settings may include inserting the one or more sensor settings information into a new entry (e.g., a new row) of table 21140 (illustrated in FIG. 21). In another instance, storing the one or more sensor settings may include updating information, associated with the one or more sensor settings, of an entry (e.g., a row) of table 21140. If button and/or icon 14120 (illustrated in FIG. 14) is selected and/or actuated, any changes to one or more sensor settings may be discarded at 31220. For example, any changes associated with one or more sensor settings may be discarded.

Turning now to FIG. 32, an exemplary method of operating an operational settings interface is illustrated, according to one or more embodiments. At 32110, it may be determined if a button and/or icon has been selected and/or actuated. If a button and/or icon has been selected and/or actuated, the method may proceed to 32130. If a button and/or icon has not been selected and/or actuated, text input may be received at 32120. In one example, a location of a reference graphic may be received via input area 15240 (as illustrated in FIG. 15). In another example, a location of a reference graphic may be received via input area 15250 (as illustrated in FIG. 15).

At 32130, a button and/or icon that has been selected and/or actuated may be determined. If dropdown menu 15210 (as illustrated in FIG. 15) is selected and/or actuated, an affirmative or a negative indication may be received, at 32140, where the affirmative or the negative indication may indicate if a rain sensor is to be bypassed. If dropdown menu 15220 (as illustrated in FIG. 15) is selected and/or actuated, an affirmative or a negative indication may be received, at 32150, where the affirmative or the negative indication may indicate if a master valve is utilized in a fluid distribution system. In one example, electrically actuated fluid valve 1210 may be a master valve of a fluid distribution system as illustrated in FIG. 1. In another example, a fluid distribution system, as illustrated in FIG. 2, may not include a master valve.

If dropdown menu 15230 (as illustrated in FIG. 15) is selected and/or actuated, an amount of time may be received, at 32160, where the amount of time indicates an amount of time that may transpire in delaying one or more of a fluid distribution program and a fluid distribution schedule, among others. In one example, the amount of time indicates an amount of time that may transpire in delaying a lawn watering program. In another example, the amount of time indicates an amount of time that may transpire in delaying a lawn watering schedule.

If button and/or icon 15260 (as illustrated in FIG. 15) is selected and/or actuated, a file menu may be provided at 32170. For example, a user may select a file that includes a reference graphic from the file menu that may be displayed in response to the user selecting and/or actuating file selection button and/or icon 15260. For instance, a location of the selected file may be provided via input area 15250.

If button and/or icon 15110 (illustrated in FIG. 15) is selected and/or actuated, one or more operational settings may be saved at 32180. For example, one or more operational settings may be stored in a memory medium, added to controller table 21120 (illustrated in FIG. 21), and/or information associated with the one or more operational settings may be utilized to update controller table 21120. In one instance, storing the one or more operational settings may include inserting the one or more operational settings information into a new entry (e.g., a new row) of table 21120 (illustrated in FIG. 21). In another instance, storing the one or more operational settings may include updating information, associated with the one or more operational settings, of an entry (e.g., a row) of table 21120. If button and/or icon 15120 (illustrated in FIG. 15) is selected and/or actuated, any changes to one or more operational may be discarded at 32190. For example, any changes associated with one or more operational settings may be discarded.

Turning now to FIG. 33, an exemplary method of operating a weather settings interface is illustrated, according to one or more embodiments. At 33110, it may be determined if a button and/or icon has been selected and/or actuated. If a button and/or icon has been selected and/or actuated, the method may proceed to 33130. If a button and/or icon has not been selected and/or actuated, text input may be received at 33120. For example, a location may be received via input area 16250 (as illustrated in FIG. 16). For instance, a zip code may be received via input area 16250.

At 33130, a button and/or icon that has been selected and/or actuated may be determined. If dropdown menu 16210 (as illustrated in FIG. 16) is selected and/or actuated, an amount of time of an extended forecast may be received at 33140. If dropdown menu 16220 (as illustrated in FIG. 16) is selected and/or actuated, a percentage of a chance of rain may be received at 33150. For example, the percentage of a chance of rain may include a number. For instance, system 1410 may not provide water to one or more zones, which may provide water to respective one or more sprinklers, if a forecasted percentage of a chance of rain exceeds the percentage of a chance of rain received at 33150.

If dropdown menu 16230 (as illustrated in FIG. 16) is selected and/or actuated, a temperature may be received at 33160. For example, the temperature may include a number. For instance, system 1410 may not provide water to one or more zones, which may provide water to respective one or more sprinklers, if a measured temperature (e.g., via a sensor, via a computing device coupled to a network, etc.) is at or below the temperature received at 33160. If dropdown menu 16240 (as illustrated in FIG. 16) is selected and/or actuated, a wind speed may be received at 33170. For example, the wind speed may include a number. For instance, system 1410 may not provide water to one or more zones, which may provide water to respective one or more sprinklers, if a measured wind speed (e.g., via a sensor, via a computing device coupled to a network, etc.) is at or exceeds the wind speed received at 33170.

If button and/or icon 16110 (illustrated in FIG. 16) is selected and/or actuated, one or more weather settings may be saved at 33180. For example, one or more weather settings may be stored in a memory medium, added to weather table 21130 (illustrated in FIG. 21), and/or information associated with the one or more weather settings may be utilized to update weather table 21130. In one instance, storing the one or more weather settings may include inserting the one or more operational settings information into a new entry (e.g., a new row) of table 21130 (illustrated in FIG. 21). In another instance, storing the one or more weather settings may include updating information, associated with the one or more weather settings, of an entry (e.g., a row) of table 21130. If button and/or icon 16120 (illustrated in FIG. 16) is selected and/or actuated, any changes to one or more weather settings may be discarded at 33190. For example, any changes associated with one or more weather settings may be discarded.

Turning now to FIG. 34, an exemplary method of operating a system settings interface is illustrated, according to one or more embodiments. At 34110, it may be determined if a button and/or icon has been selected and/or actuated. If a button and/or icon has been selected and/or actuated, the method may proceed to 34130. If a button and/or icon has not been selected and/or actuated, text input may be received at 34120. In one example, an SSID may be received via input area 17220 (as illustrated in FIG. 17). In a second example, an encryption key may be received via input area 17240 (as illustrated in FIG. 17). In a third example, a location and/or address of a time server may be received via input area 17260 (as illustrated in FIG. 17). In a fourth example, a login name and/or a user name may be received via input area 17290 (as illustrated in FIG. 17). In another example, a password may be received via input area 17295 (as illustrated in FIG. 17).

At 34130, a button and/or icon that has been selected and/or actuated may be determined. If dropdown menu 17210 (as illustrated in FIG. 17) is selected and/or actuated, a wireless mode of operation may be received at 34140. For example, a WiFi mode of operation may be received. If button and/or icon 17225 (as illustrated in FIG. 17) is selected and/or actuated, information indicating a search may be received at 33150. At 34160, a search for one or more wireless networks may be performed. In one or more embodiments, searching for one or more wireless networks may include receiving one or more SSIDs from respective one or more wireless access points. At 34170, data for an access point search menu may be provided via a network interface. For example, data for access point search menu 18010 (as illustrated in FIG. 18) may be provided via the network interface.

If dropdown menu 17230 (as illustrated in FIG. 17) is selected and/or actuated, an encryption method may be received at 34180. If dropdown menu 17250 (as illustrated in FIG. 17) is selected and/or actuated, a time zone may be received at 34190. If a checkbox 17270 (as illustrated in FIG. 17) is selected and/or actuated, information indicating a required login may be received at 34200. If a checkbox 17280 (as illustrated in FIG. 17) is selected and/or actuated, information indicating a login is not required may be received at 34210. In one or more embodiments, selecting and/or actuating a checkbox of checkboxes 17270 and 17280 may unselect and/or deselect the other checkbox. In one example, selecting and/or actuating checkbox 17270 may unselect and/or deselect checkbox 17280. In one example, selecting and/or actuating checkbox 17280 may unselect and/or deselect checkbox 17270.

If button and/or icon 17110 (illustrated in FIG. 17) is selected and/or actuated, one or more system settings may be saved at 34220. For example, one or more system settings may be stored in a memory medium, added to a database table, and/or information associated with the one or more system settings may be utilized to update a database table. In one instance, storing the one or more system settings may include inserting the one or more system settings information into a new entry (e.g., a new row) of a database table. In another instance, storing the one or more system settings may include updating information, associated with the one or more system settings, of an entry (e.g., a row) of a database table. If button and/or icon 17120 (illustrated in FIG. 17) is selected and/or actuated, any changes to one or more system settings may be discarded at 34230. For example, any changes associated with one or more system settings may be discarded.

Turning now to FIG. 35, an exemplary method of operating an administration interface is illustrated, according to one or more embodiments. At 35110, it may be determined if a button and/or icon has been selected and/or actuated. If a button and/or icon has been selected and/or actuated, the method may proceed to 35130. If a button and/or icon has not been selected and/or actuated, text input may be received at 35120. In one example, a location of backup may be received via input area 19210 (as illustrated in FIG. 19). In another example, a location of a firmware update may be received via input area 19260 (as illustrated in FIG. 19).

At 35130, a button and/or icon that has been selected and/or actuated may be determined. If button and/or icon 19220 (as illustrated in FIG. 19) is selected and/or actuated, a file menu may be provided at 35140. For example, a user may select a file that includes a backup (e.g., a backup data file) from the file menu that may be displayed in response to the user selecting and/or actuating file selection button and/or icon 19220. For instance, a location of the selected file may be provided via input area 19210.

If button and/or icon 19230 (as illustrated in FIG. 19) is selected and/or actuated, a backup (e.g., a backup data file) may be received at 35150. In one or more embodiments, backup data may include one or more portions of one or more of APP data 5036, schedule data 5037 (as illustrated in FIG. 5), and database data 5038, among others. If button and/or icon 19240 (as illustrated in FIG. 19) is selected and/or actuated, a restore from a backup may be canceled at 35160. For example, input area 19210 may be cleared. If button and/or icon 19250 (as illustrated in FIG. 19) is selected and/or actuated, a backup (e.g., a backup data file) may be provided to a computer system at 35170. For example, system 1410 may create the backup and provide the backup to a computer system (e.g., a CD of CDs 22110-22112). For instance, backup data may include one or more portions of one or more of APP data 5036, schedule data 5037 (as illustrated in FIG. 5), and database data 5038, among others. In one or more embodiments, the backup may be provided to the computer system via a network.

If button and/or icon 19270 (as illustrated in FIG. 19) is selected and/or actuated, a file menu may be provided at 35180. For example, a user may select a file that includes a firmware update from the file menu that may be displayed in response to the user selecting and/or actuating file selection button and/or icon 19270. For instance, a location of the selected file may be provided via input area 19260. If button and/or icon 19280 (as illustrated in FIG. 19) is selected and/or actuated, a firmware update may be received at 35190. If button and/or icon 19290 (as illustrated in FIG. 19) is selected and/or actuated, a firmware update may be canceled at 35200. For example, input area 19260 may be cleared. If button and/or icon 19110 (as illustrated in FIG. 19) is selected and/or actuated, a system restart may be performed at 35210. For example, device 3110 may be restarted and/or rebooted.

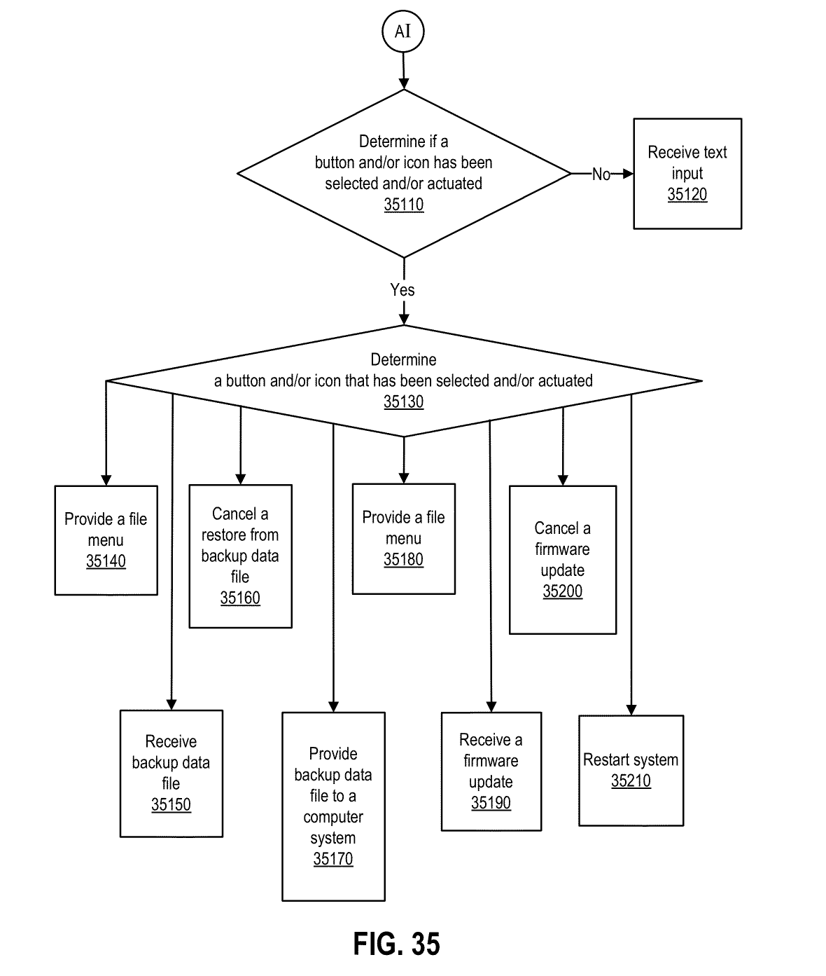

Turning now to FIG. 36, exemplary graphics of a watering system are illustrated, according to one or more embodiments. As shown, graphics 36010-36040 may be of different sizes. In one or more embodiments, graphics 36010-36040 may be included in an animation. For example, the animation may indicate via an interface that a zone of a sprinkler system is active.

In one instance, the animation may indicate via data interface 6040 that a zone corresponding to zone icon and/or graphic 8170 is active (as illustrated in FIG. 8), where the animation may be displayed in place of zone icon and/or graphic 8170. In a second instance, the animation may indicate via data interface 6040 that a zone corresponding to zone icon and/or graphic 8110 is active (as illustrated in FIG. 8), where the animation may be displayed in place of zone icon and/or graphic 8110. In another instance, the animation may indicate via data interface 6040 that a zone corresponding to zone icon and/or graphic 8150 is active (as illustrated in FIG. 8), where the animation may be displayed in place of zone icon and/or graphic 8150.

In one or more embodiments, each of graphics 36010-36040 may be utilized in a frame of a set of frames of the animation. In one example, the set of frames may cycle through graphics 36010-36040. In another example, the set of frames may cycle back and forth through graphics 36010-36040.

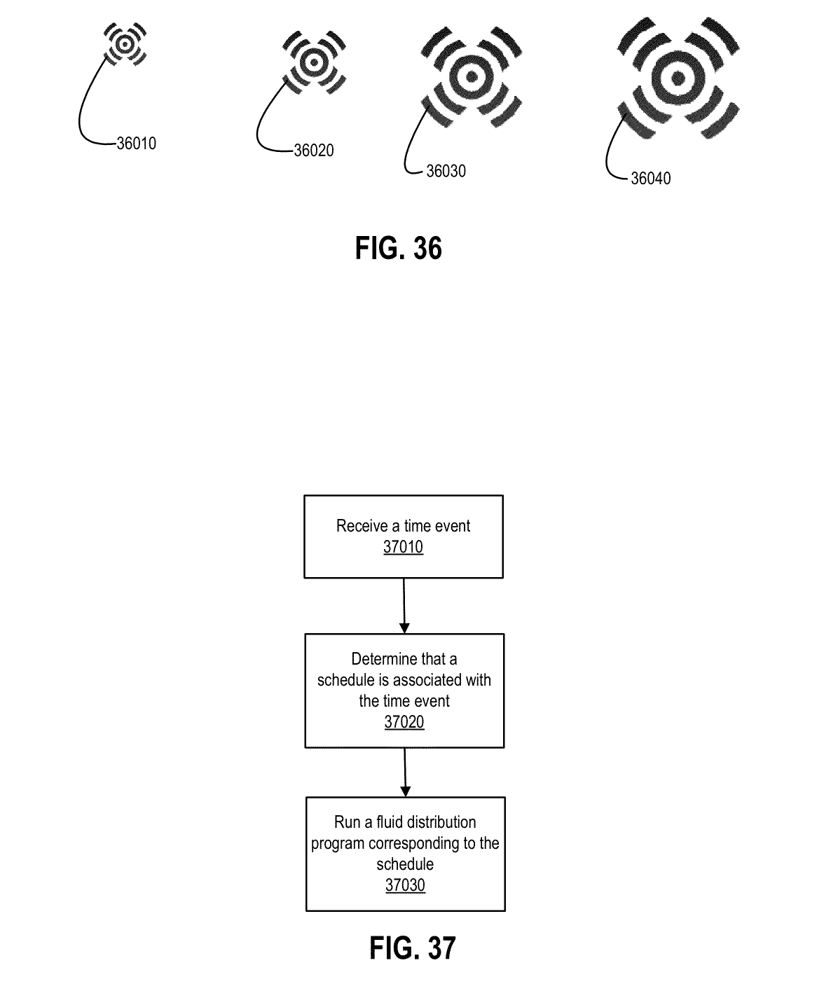

Turning now to FIG. 37, an exemplary method of operating a fluid distribution controller illustrated, according to one or more embodiments. At 37010, a time event may be received. In one or more embodiments, the time event may include a timeout and/or a clock event. In one example, a system, method, and/or process described herein may wait for the time event before proceeding to another method and/or process. In another example, a system, method, and/or process described herein may wait for the time event before proceeding to a portion of a method and/or process.

In one or more embodiments, a method and/or process may receive time events and run and/or execute one or more of a method, a process, and a program in response to receiving the time events or one or more of the time events. For example, a daemon may run and/or execute one or more of a method, a process, and a program at a time interval. For instance, a time event may include an on the minute time event, and a cron daemon may run and/or execute one or more of a method, a process, and a program every minute. In one or more embodiments, scheduling information of the cron daemon may be stored in schedule data 5037, as illustrated in FIG. 5.

At 37020, it may be determined that a schedule is associated with the time event. For example, the time event may correspond to a time, and a schedule may correspond to the time, as well. In one instance, a schedule associated with a name “Morning” (as illustrated in FIG. 13) may correspond to the time (e.g., 5:00 AM) corresponding to the time event and a start time of the schedule. In another instance, the one or more of the method, the process, and the program that was run and/or executed by the cron daemon may determine that a schedule is associated with the time event and/or a running and/or execution of the one or more of the method, the process, and the program.

At 37030, a fluid distribution program may be run and/or executed that corresponds to the schedule. For example, a fluid distribution program associated with the name “July Program” (e.g., see FIGS. 11 and 13) may be run and/or executed.

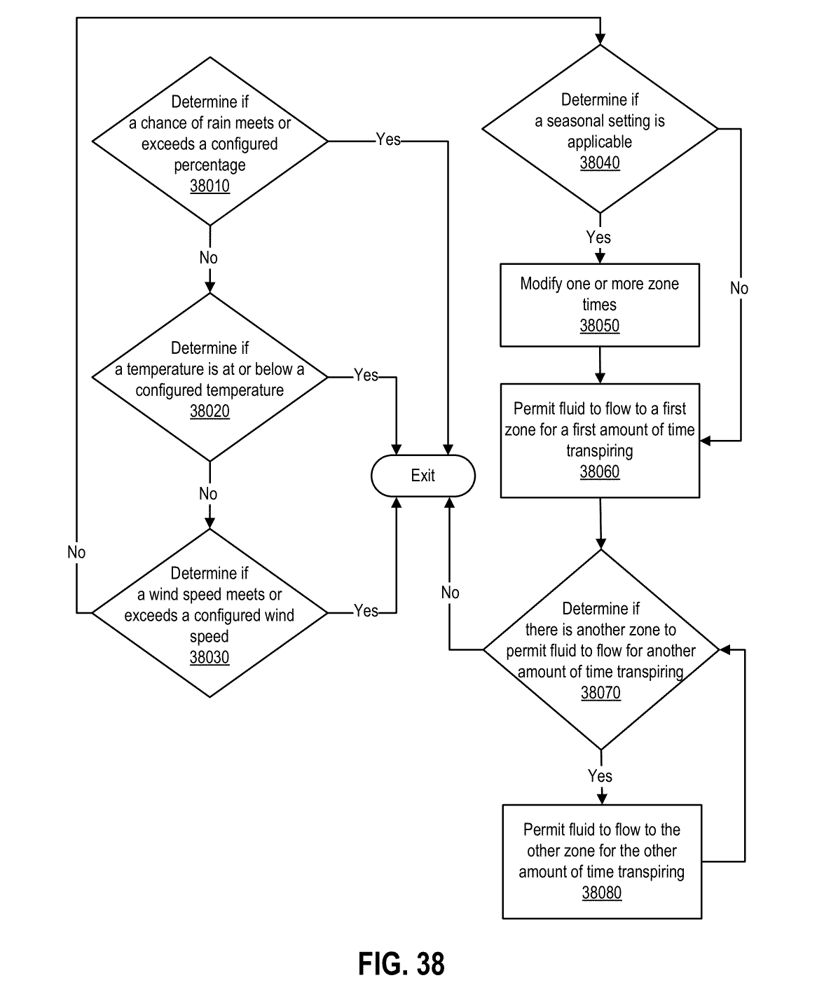

Turning now to FIG. 38, an exemplary method of running a program corresponding to a schedule is illustrated, according to one or more embodiments. At 38010, it may be determined if a chance of rain meets or exceeds a configured percentage. For example, it may be determined if a chance of rain meets or exceeds sixty percent as illustrated in FIG. 16. For instance, it may be determined if a chance of rain meets or exceeds sixty percent within a three hour extended forecast as illustrated in FIG. 16. If the chance of rain meets or exceeds the configured percentage, the method may exit and/or cease operations. For example, a running and/or execution of the program corresponding to the schedule may cease.

If the chance of rain does not meet or exceed the configured percentage, it may be determined if a temperature is at or below a configured temperature, at 38020. For example, it may be determined if a temperature (e.g., an outdoor temperature) is at or below thirty-four degrees Fahrenheit as illustrated in FIG. 16. If a temperature is at or below a configured temperature, the method may exit and/or cease operations. For example, a running and/or execution of the program corresponding to the schedule may cease.

If a temperature is not at or below a configured temperature, it may be determined if a wind speed meets or exceeds a configured wind speed, at 38030. For example, it may be determined if a wind speed meets or exceeds twenty MPH as illustrated in FIG. 16. If the wind speed meets or exceeds the configured wind speed, the method may exit and/or cease operations. For example, a running and/or execution of the program corresponding to the schedule may cease.

If the wind speed does not meet or exceed the configured wind speed, it may be determined if a seasonal setting is applicable, at 38040. In one or more embodiments, determining if a seasonal setting is applicable may include determining a current date and determining if the current date is within a “From Date” and a “To Date” of a season (e.g., see FIG. 12). For example, determining if the current date is within a “From Date” and a “To Date” of a season may include determining if the current date is within columns “start_month” and “start_day” and columns “end_month” and “end_day” of a row of table 20110 (as illustrated in FIG. 20). In one or more embodiments, accessing one or more rows of a table, described herein, may include accessing a DBMS and/or accessing database data 5038 (as illustrated in FIG. 5).

If a seasonal setting is applicable, one or more times that fluid is permitted to flow via respective one or more zones may be modified at 38050. For example, the one or more times that fluid is permitted to flow via respective the one or more zones may be modified by a percentage. For instance, the percentage may be included in a column of table 20110 (illustrated in FIG. 20) of the row where the current date is within columns “start_month” and “start_day” and columns “end_month” and “end_day” of the row of table 20110. If a seasonal setting is not applicable, the method may proceed to 38060.

At 38060, fluid may be permitted to flow to a first zone for a first amount of time transpiring. For example, water may be permitted to flow to a first zone for a first amount of time transpiring. In one instance, water may be permitted to flow to the first zone (e.g., a zone associated with the name “Zone 1” as illustrated in FIG. 11) for five minutes. In another instance, if a configured amount of time of permitting water to flow to the first zone is modified by fifty percent (e.g., modified via an applicable season at 38050), water may be permitted to flow to the first zone (e.g., a zone associated with the name “Zone 1” as illustrated in FIG. 11) for two minutes and thirty seconds.

In one or more embodiments, permitting fluid to flow for an amount of time transpiring may include actuating an electrically actuated fluid valve. For example, system 1410 may actuate electrically actuated fluid valve 1240 to permit water to flow to a zone of a water sprinkler system. In one instance, actuating electrically actuated fluid valve 1240 for an amount of time transpiring may include providing one or more a signal, a voltage, and a current to electrically actuated fluid valve 1240 to open electrically actuated fluid valve 1240 such that water is permitted to flow through electrically actuated fluid valve 1240. In a second instance, actuating electrically actuated fluid valve 1240 for an amount of time transpiring may include providing one or more a signal, a voltage, and a current to electrically actuated fluid valve 1240 to close electrically actuated fluid valve 1240 such that water is not permitted to flow through electrically actuated fluid valve 1240. In another instance, actuating electrically actuated fluid valve 1240 for an amount of time transpiring may include no longer providing one or more a signal, a voltage, and a current to electrically actuated fluid valve 1240 to close electrically actuated fluid valve 1240 such that water is not permitted to flow through electrically actuated fluid valve 1240. In another embodiment, fluid may only be allowed to flow through electrically actuated fluid valve 1240 when a water restriction requirement is met.

At 38070, it may be determined if there is another zone to permit fluid to flow for another amount of time transpiring. If there is not another zone to permit fluid to flow for another amount of time transpiring, the method may exit and/or cease operations. For example, a running and/or execution of the program corresponding to the schedule may cease. If there is another zone to permit fluid to flow for another amount of time transpiring, the method may proceed to 38080.

At 38080, fluid may be permitted to flow to the other zone for the other amount of time transpiring. For example, water may be permitted to flow to the other zone for the other amount of time transpiring. In one or more embodiments, the method may proceed to 38070. For example, method elements 38070 and 38080 may process zones associated with zone names “Zone 2”, “Zone 3”, “Zone 4”,“Zone 5”, “Zone 6”, “Zone 7”, and “Zone 8”, as illustrated in FIG. 11. In another embodiment, zones are only processed when a water restriction requirement is met.

In one or more embodiments, one or more of multiple schedules, multiple programs(e.g., fluid distribution programs), multiple seasons (e.g. season configurations), described herein, may be stored and/or utilized by system 1410. In one example, one or more of memory media 5020 and 5025, among others, may store the one or more of multiple schedules, multiple programs, multiple seasons. In another example, one or more of a network attached storage (NAS), a storage area network (SAN), and a network storage system, among others, may store the one or more of multiple schedules, multiple programs, multiple seasons. For instance, system 1410 may include or have a capacity to store the one or more of multiple schedules, multiple programs, multiple seasons that is associated with a capacity of one or more of memory medium 5020, memory medium 5025, a NAS, a SAN, and a network storage system (e.g., “cloud storage”), among others.

In one or more embodiments, one or more or more combinations of a schedule of multiple schedules may be combined with a program (e.g., a fluid distribution program) of multiple programs (e.g., fluid distribution programs) may be implemented and/or configured. In one or more embodiments, one or more or more combinations of a schedule of multiple schedules may be combined with a program (e.g., a fluid distribution program) of multiple programs (e.g., fluid distribution programs) and with a season of multiple seasons may be implemented and/or configured.

In one or more embodiments, the term “memory medium” may mean a “memory”, a “memory device”, and/or “tangible computer readable storage medium”. In one example, one or more of a “memory”, a “memory device”, and “tangible computer readable storage medium” may include volatile storage such as DRAM (dynamic random-access memory), SRAM (static random-access memory), Rambus DRAM, EDO (extended data out) RAM, random access memory, DDR (double data rate) RAM, SDR (single data rate) RAM, etc. In another example, one or more of a “memory”, a “memory device”, and “tangible computer readable storage medium” may include nonvolatile storage such as an EPROM (erasable programmable read-only memory), EEPROM (electrically erasable programmable read-only memory), FRAM (ferroelectric random-access memory) CD-ROM, a DVD-ROM, a floppy disk, a magnetic tape, flash memory, NVRAM, a magnetic media (e.g., a hard drive), optical storage, etc. In one or more embodiments, a memory medium may include one or more volatile storages and/or one or more nonvolatile storages.

In one or more embodiments, a computer system, a computing device, and/or a computer may be broadly characterized to include any device that includes a processor that executes instructions from a memory medium. For example, a processor (e.g., a central processing unit or CPU) may execute instructions from a memory medium that stores the instructions which may include one or more software programs in accordance with one or more of methods, processes, and/or flowcharts described herein. For instance, the processor and the memory medium, that stores the instructions which can include one or more software programs in accordance with one or more of methods, processes, and/or flowcharts described herein, may form one or more means for one or more functionalities described with references to methods, processes and/or flowcharts described herein.

In one or more embodiments, an ASIC (application specific integrated circuit) may be configured in accordance with one or more of methods, processes, and/or flowcharts described herein. For example, the ASIC may form one or more means for one or more functionalities described with references to methods, processes and/or flowcharts described herein. For instance, the ASIC may be utilized in place of processing unit 5010 and one or more of OS 5030 and APPs 5031-5033. In one or more embodiments, a FPGA (field programmable gate array) may be configured in accordance with one or more of methods, processes, and/or flowcharts described herein. For example, the FPGA may form one or more means for one or more functionalities described with references to methods, processes and/or flowcharts described herein. For instance, the FPGA may be utilized in place of processing unit 5010 and one or more of OS 5030 and APPs 5031-5033.

One or more of the method elements described herein and/or one or more portions of an implementation of a method element can be repeated, may be performed in varying orders, may be performed concurrently with one or more of the other method elements and/or one or more portions of an implementation of a method element, or may be omitted, according to one or more embodiments. In one or more embodiments, concurrently may mean simultaneously. In one or more embodiments, concurrently may mean apparently simultaneously according to some metric. For example, two tasks may be context switched such that such that they appear to be simultaneous to a human. In one instance, a first task of the two tasks may include a first method element and/or a first portion of a first method element. In a second instance, a second task of the two tasks may include a second method element and/or a first portion of a second method element. In another instance, a second task of the two tasks may include the first method element and/or a second portion of the first method element. Further, one or more of the system elements described herein may be omitted and additional system elements may be added as desired, according to one or more embodiments. Moreover, supplementary, additional, and/or duplicated method elements may be instantiated and/or performed as desired, according to one or more embodiments.

In view of this description, one or more modifications and/or alternatives of the embodiments described herein may be apparent to those skilled in the art. Accordingly, descriptions of the embodiments, described herein, are to be taken and/or construed as illustrative and/or exemplary only and are for the purpose of teaching those skilled in the art the general manner of carrying out one or more embodiments described herein. In one or more embodiments, one or more materials and/or elements can be exchanged, swapped, or substituted for those illustrated and described herein. In one or more embodiments, one or more parts, methods, and/or processes may be reversed, and/or certain one or more features of the described one or more embodiments can be utilized independently. For instance, one or more embodiments, one or more parts, methods, and/or processes may be reversed, and/or certain one or more features of the described one or more embodiments can be utilized independently, as would be apparent to one skilled in the art after having the benefit of this description.

What is claimed is:

1. An irrigation controller, comprising:
a communication interface; and
a processing unit coupled to communication interface, wherein the processing unit is configured to:
receive, via the communication interface, a request from a computing device;
communicate, via the communication interface, first data to the computing device in response to the request, wherein the first data includes a user interface that is displayable via a web browser of the computing device;
receive, via the communication interface, user data input via the user interface of the computing device; and
control at least one electrically actuated fluid valve that controls water flow to one or more in-ground sprinkler heads based on the received user data.

2. The irrigation controller of claim 1, wherein the user data includes a request for a graphical representation of real property associated with the irrigation controller and the processing unit is further configured to:
communicate, via the communication interface, second data to the computing device in response to the request, wherein the second data includes data for creating the graphical representation.

3. The irrigation controller of claim 2, wherein the user data includes data associated with moving a new zone icon to a location on the graphical representation and the processing unit is further configured to:
store zone information associated with the new zone icon in an associated memory.

4. The irrigation controller of claim 2, wherein the user data includes data associated with moving an existing zone icon to a different location on the graphical representation and the processing unit is further configured to:
store zone information associated with the moved existing zone icon in an associated memory.

5. The irrigation controller of claim 2, wherein the user data includes data associated with removing an existing zone icon on the graphical representation and the processing unit is further configured to:
remove zone information associated with the removed existing zone icon in an associated memory.

6. The irrigation controller of claim 2, wherein the user data includes data associated with selection of an existing zone icon on the graphical representation and the processing unit is further configured to:
communicate, for the selected existing zone icon, zone control menu information to the computing device for display via the user interface.

7. The irrigation controller of claim 1, wherein the user data includes data associated with user input to a program interface and the processing unit is further configured to:
modify, in an associated memory, an amount of time for respective zones to permit water flow based on the user data;
store, in the associated memory, a program based on the user data;
delete, in the associated memory, an existing program based on the user data;
cancel changes to a program, in the associated memory, based on the user data; and
communicate, data associated with a different program, to the computing device for display via the user interface.

8. The irrigation controller of claim 1, wherein the user data includes data associated with user input to a seasonal setting interface and the processing unit is further configured to:
receive, via the communication interface, one or more of a ‘season name’, a ‘from date’, a ‘to date’, and a percentage; and
store, in an associated memory, the one or more of the ‘season name’, the ‘from date’, the ‘to date’, and the percentage.

9. The irrigation controller of claim 1, wherein the user data includes data associated with user inputs to a schedules interface and the processing unit is further configured to:
receive, via the communication interface, one or more of a ‘schedule name’, a ‘start time’, a ‘program’ name, a ‘season’, an ‘active’ indication, and a ‘run on day’ indication; and
store, in an associated memory, one or more of the ‘schedule name’, the ‘start time’, the ‘program’ name, the ‘season’, the ‘active’ indication, and the ‘run on day’ indication.

10. The irrigation controller of claim 1, wherein the user data includes data associated with user input to a sensor settings interface and the processing unit is further configured to:
receive, via the communication interface, one or more of a ‘rain sensor’ present indication, a ‘rain sensor type’, a ‘garage door sensor’ present indication, a ‘close after’ indication for the garage door sensor, and a ‘close at’ time for the garage door sensor; and
store, in an associated memory, the one or more of the ‘rain sensor’ present indication, the ‘rain sensor type’, the ‘garage door sensor’ present indication, the ‘close after’ indication for the garage door sensor, and the ‘close at’ time for the garage door sensor.

11. The irrigation controller of claim 1, wherein the user data includes data associated with user input to an operational settings interface and the processing unit is further configured to:
receive, via the communication interface, one or more of a ‘bypass rain sensor’ indication, a ‘master valve’ present indication, and a ‘delay watering’ period; and
store, in an associated memory, the one or more of the ‘bypass rain sensor’ indication, the ‘master valve’ present indication, and the ‘delay watering’ period.

12. The irrigation controller of claim 1, wherein the user data includes data associated with user input to a weather settings interface and the processing unit is further configured to:
receive, via the communication interface, one or more of an ‘extend forecast to’ time, a ‘forecast zip code’, and one or more ‘do not water if’ conditions; and
store, in an associated memory, one or more of the ‘extend forecast to’ time, the ‘forecast zip code’, and the one or more ‘do not water if’ conditions.

13. The irrigation controller of claim 1, wherein the communication interface is a wired interface or a wireless interface.

14. The irrigation controller of claim 1, wherein the irrigation controller provides a wireless access point.

15. The irrigation controller of claim 1, wherein the computing device is a smartphone or a tablet computer.

16. An irrigation system, comprising:
an electrically actuated water valve;
one or more in-ground sprinkler heads mechanically coupled to the electrically actuated water valve; and
an irrigation controller, including:
a communication interface; and
a processing unit coupled to communication interface, wherein the processing unit is configured to:
receive, via the communication interface, a request from a computing device;
communicate, via the communication interface, first data to the computing device in response to the request, wherein the first data includes a user interface that is displayable via a web browser of the computing device;
receive, via the communication interface, user data input via the user interface of the computing device; and
control the electrically actuated water valve to provide water to the one or more in-ground sprinkler heads based on the received user data.

17. The irrigation system of claim 16, wherein the communication interface includes a wired interface and a wireless interface.

18. The irrigation system of claim 16, wherein the irrigation controller provides a wireless access point.

19. A method of operating an irrigation controller, comprising:
receiving, via a communication interface, a request from a computing device;
communicating, via the communication interface, first data to the computing device in response to the request, wherein the first data includes a user interface that is displayable via a web browser of the computing device;
receiving, via the communication interface, user data input via the user interface of the computing device; and
controlling at least one electrically actuated fluid valve that is mechanically coupled to one or more in-ground sprinkler heads based on the received user data.

20. The method of claim 19, wherein the user data includes a request for a graphical representation of real property associated with the irrigation controller and the method further comprises:
communicating, via the communication interface, second data to the computing device in response to the request, wherein the second data includes data for creating the graphical representation.
